(19) United States
(12) Patent Application Publication
(10) Pub. No.: US 2015/0220935 A1
(43) Pub. Date: Aug. 6, 2015

(54) PAYMENT SERVICE SUPPORT APPARATUS, PAYMENT SERVICE SUPPORT SYSTEM, AND PAYMENT SERVICE SUPPORT METHOD

(71) Applicant: PANASONIC INTELLECTUAL PROPERTY MANAGEMENT CO., LTD., Osaka (JP)

(72) Inventor: Kazuhiko IWAI, Kanagawa (JP)

(73) Assignee: PANASONIC INTELLECTUAL PROPERTY MANAGEMENT CO., LTD., Osaka (JP)

(21) Appl. No.: 14/612,694

(22) Filed: Feb. 3, 2015

(30) Foreign Application Priority Data
Feb. 6, 2014 (JP) 2014-021048

(51) Int. Cl. G06Q 30/00; G07G 1/01

(52) U.S. Cl. CPC G06Q 30/016; G07G 1/01

(57) ABSTRACT

Provided is a payment service support apparatus including: a payment waiting state detector which detects a state of a customer waiting for a payment, based on an image obtained by imaging a payment waiting area where customers waiting at a cash register for a payment stay; a person-in-store state detector which detects a state of persons staying in the store, based on an image obtained by imaging the inside of the store; an alert determinator which determines advisability of an alert instructing an action to decrease the customer's waiting time for the payment, based on the detected result of the payment waiting state detector and the detected result of the person-in-store state detector; and an alert executer which makes the alert, based on the determined result of the alert determinator.

### TECHNICAL FIELD

The present invention relates to a payment service support apparatus, a payment service support system, and a payment service support method which support payment service in a store so as to decrease customer's waiting time for payment, based on an image obtained by imaging the inside of the store.

### BACKGROUND OF THE INVENTION

If the number of customers waiting for payment at a cash register is increased and the customers need to wait for a long time in a store such as a convenience store, customer satisfaction is decreased and this leads to loss of sales opportunities. In order to decrease the customer's waiting time for payment, it is necessary for a sales clerk or a store manager to constantly grasp the state of the inside of the store and to appropriately determine necessity of an action to decrease the customer's waiting time for payment. However, this becomes great burden on a sales clerk or a store manager, and thus, a technology of supporting payment service in the store so as to decrease the customer's waiting time for payment is desirable.

Japanese Patent Unexamined Publication No. 2002-366621 discloses a technology of installing a security camera or a microphone in a store, generating information regarding states of customers, based on an image obtained from the security camera or a voice obtained from the microphone, and transmitting this information to a terminal of the head office. Japanese Patent Unexamined Publication No. 2006-221367 discloses a technology of detecting customers visiting a store with an infrared sensor, obtaining information regarding operation states from cash registers, and obtaining the number of additionally necessary cash registers based on the number of customers staying in the store and the number of cash registers in the operation, and transmitting this information to a terminal of the store.

### SUMMARY OF THE INVENTION

A payment service support apparatus according to an embodiment of the invention supports payment service in a store so as to decrease customer's waiting time for payment, based on an image obtained by imaging the inside of the store. The payment service support apparatus includes: a payment waiting state detector which detects a state of a customer waiting for a payment, based on an image obtained by imaging a payment waiting area where customers waiting at a cash register for a payment stay; a person-in-store state detector which detects a state of persons staying in the store, based on an image obtained by imaging the inside of the store; an alert determinator which determines advisability of an alert instructing an action to decrease the customer's waiting time for the payment, based on the detected result of the payment waiting state detector and the detected result of the person-in-store state detector; and an alert executer which makes the alert, based on the determined result of the alert determinator.

### BRIEF DESCRIPTION OF DRAWINGS

FIG. 1 is an overall configuration diagram of a payment service support system according to the embodiment;

FIG. 2A is a plan view of a store illustrating a layout of the store and an installation situation of cameras 1;

FIG. 2B is a plan view of a store illustrating a layout of the store and an installation situation of cameras 1;

FIG. 3 is a functional block diagram showing a schematic configuration of PC 3 installed in a store;

FIG. 4 is an explanatory diagram showing various areas set in the store;

FIG. 5 is an explanatory diagram illustrating an outline of a alert determination process performed by alert determinator 45;

FIG. 6 is an explanatory diagram illustrating an outline of an alert determination process performed by alert determinator 45;

FIG. 7 is an explanatory diagram illustrating an outline of a alert determination process performed by alert determinator 45;

FIG. 8 is a flowchart illustrating procedures of an alert determination process performed by alert determinator 45;

FIG. 9 is a flowchart illustrating procedures of an alert determination process performed by alert determinator 45;

FIG. 10 is a flowchart illustrating procedures of an alert determination process performed by alert determinator 45;

FIG. 11 is an explanatory diagram illustrating a situation in a store of a case A shown in FIG. 6;

FIG. 12 is an explanatory diagram illustrating a situation in a store of a case A shown in FIG. 6;

FIG. 13A is an explanatory diagram illustrating a situation in a store of a case A shown in FIG. 6;

FIG. 13B is an explanatory diagram illustrating a situation in a store of a case A shown in FIG. 6;

FIG. 13C is an explanatory diagram illustrating a situation in a store of a case A shown in FIG. 6;

FIG. 14A is an explanatory diagram illustrating a situation in a store of a case A shown in FIG. 6;

FIG. 14B is an explanatory diagram illustrating a situation in a store of a case A shown in FIG. 6;

FIG. 15A is an explanatory diagram illustrating a situation in a store of a case B shown in FIG. 7;

FIG. 15B is an explanatory diagram illustrating a situation in a store of a case B shown in FIG. 7;

FIG. 15C is an explanatory diagram illustrating a situation in a store of a case B shown in FIG. 7;

FIG. 16A is an explanatory diagram illustrating a situation in a store of cases C and D shown in FIG. 5;

FIG. 16B is an explanatory diagram illustrating a situation in a store of cases C and D shown in FIG. 5;

FIG. 17 is an explanatory diagram showing a payment operation situation display screen displayed on monitor 4 of a store and monitor 12 of a head office;

FIG. 18 is an explanatory diagram showing a payment operation situation display screen displayed on monitor 4 of a store and monitor 12 of a head office;

FIG. 19 is an explanatory diagram showing a payment operation situation display screen displayed on monitor 4 of a store and monitor 12 of a head office;

FIG. 20 is an explanatory diagram showing an alert screen displayed on portable terminal 5;

FIG. 21A is an explanatory diagram showing an alert situation display screen displayed on monitor 4 of a store and monitor 12 of a head office;

FIG. 21B is an explanatory diagram showing an alert situation display screen displayed on monitor 4 of a store and monitor 12 of a head office;

FIG. 22 is an explanatory diagram illustrating a situation in a store of a modification example of a payment service support system according to the embodiment; and

FIG. 23 is an explanatory diagram illustrating a situation in a store of a modification example of a payment service support system according to the embodiment.

### DETAILED DESCRIPTION OF THE PREFERRED EMBODIMENTS

A payment service support apparatus according to an embodiment of the invention supports payment service in a store so as to decrease customer's waiting time for payment, based on an image obtained by imaging the inside of the store. The payment service support apparatus includes: a payment waiting state detector which detects a state of a customer waiting for a payment, based on an image obtained by imaging a payment waiting area where customers waiting at a cash register for a payment stay; a person-in-store state detector which detects a state of persons staying in the store, based on an image obtained by imaging the inside of the store; an alert determinator which determines advisability of an alert instructing an action to decrease the customer's waiting time for the payment, based on the detected result of the payment waiting state detector and the detected result of the person-in-store state detector; and an alert executer which makes the alert, based on the determined result of the alert determinator.

In this case, since the state of the customers waiting for the payment is detected from the image, the state of the persons staying in the store is detected from the image, and the advisability of the alert instructing a sales clerk to perform the action to decrease the customer's waiting time for the payment is determined by considering both of the state of the customer waiting for the payment and the state of the person staying in the store, it is possible to optimize the timing of the alert and to decrease the unnecessary alerts.

The payment service support apparatus according to the embodiment of the invention further includes: a sales clerk state detectior which detects a state of the sales clerk staying in the store, based on the image obtained by imaging the inside of the store; and a cash register state detector which detects the state of the cash register, and the alert determinator makes a determination to make an alert of instructing an operation of the cash register, when it is determined that the cash register is able to be newly operated, based on the detected result of the sales clerk state detector and the detected result of the cash register state detector.

In this case, it is possible to decrease the unnecessary alerts. That is, when it is difficult to newly operate a manned cash register, although the alert instructing the operation of the manned cash register is made, this merely results in the unnecessary operation of the sales clerk. When it is possible to newly operate manned cash register, it is possible to avoid the unnecessary operation of the sales clerk by making the alert of instructing the operation of manned cash register.

Herein, the alert determinator determines that the cash register can be newly operated, when sales clerk state detector detects that there is a sales clerk who is able to newly participate in the payment operation, and the cash register state detector detects that there is the stopped cash register.

In the payment service support apparatus according to the embodiment of the invention, the alert determinator makes a determination not to make an alert, when the payment waiting state detector detects that there are a lot of customers waiting for the payment and the person-in-store state detector detects that the store is not crowded.

In this case, it is possible to decrease the unnecessary alerts. That is, even when there are a lot of the customers waiting for the payment, in a state where the store is not crowded, an immediate decrease in the number of customers waiting for the payment is expected. In such a case, even when the action to decrease the customer's waiting time for the payment is performed, this may be an unnecessary action, in many cases, and it is possible to avoid the unnecessary action of the sales clerk by not making the alert in this case.

In the payment service support apparatus according to the embodiment of the invention, manned cash registers and unmanned cash registers are installed in the store, and the alert determinator makes a determination to perform an alert of instructing guidance recommending using the unmanned cash register to the customer waiting at the manned cash registers for the payment, when the payment waiting state detector detects that there are a lot of customers waiting at the manned cash register for the payment.

In this case, the sales clerk performs guidance recommending using the unmanned cash register to the customer waiting at the manned cash register for the payment, and when the customer uses the unmanned cash register according to this, it is possible to decrease the customer's waiting time for the payment.

The payment service support apparatus according to the embodiment of the invention further includes: a sales clerk state detector which detects a state of the sales clerk staying in the store, based on the image obtained by imaging the inside of the store; and a cash register state detector which at least detects a state of the manned cash registers, and the alert determinator makes a determination to make the alert of instructing guidance recommending using the unmanned cash register to the customer waiting at the manned cash registers for the payment, when the payment waiting state detector detects that there are a lot of customers waiting at the manned cash register for the payment and when it is determined that it is difficult to newly operate the manned cash register, based on the detected result of the sales clerk state detector and the detected result of the cash register state detector, and the alert determinator makes a determination to make the alert of instructing the operation of the manned cash register, when it is determined that the manned cash register is able to be newly operated.

In this case, when it is determined that it is difficult newly operate the manned cash register, the guidance recommending using the unmanned cash register to the customer is performed, and when the manned cash register can be newly operated, the manned cash register is operated to perform the payment operation, and therefore, it is possible to increase customer satisfaction.

The payment service support apparatus according to the embodiment of the invention further includes: a sales clerk state detector which detects a state of the sales clerk staying in the store, based on the image obtained by imaging the inside of the store; and a cash register state detector which detects the state of the cash register, and the alert determinator makes a determination to make an alert of instructing support of a payment operation at the cash register, when the payment waiting state detector detects that there are a lot of customers waiting for the payment, the person-in-store state detector detects that the store is crowded, the sales clerk state detector detects that there is a sales clerk who is able to participate in the payment operation, and the cash register state detector detects that all of the cash registers are already operated.

In this case, even when it is difficult to newly operate the cash registers, when there is the sales clerk who can participate in the payment operation, the alert of instructing the support of the payment operation is made to cause the other sales clerks to work for the assistance operation of assisting the sales clerk operating cash register, and accordingly, it is possible to shorten the time required for the payment, and therefore, it is possible to decrease the customer's waiting time.

The payment service support apparatus according to the embodiment of the invention further includes: a sales clerk state detector which detects a state of the sales clerk staying in the store, based on the image obtained by imaging the inside of the store, and the alert determinator makes a determination to make an alert of instructing assembly in a payment operation area where the sales clerks perform the payment operation, when the payment waiting state detector detects that there is a small number of customers waiting for the payment, the person-in-store state detector detects that the store is crowded, and the sales clerk state detector detects that there is a sales clerk who is able to participate in the payment operation.

In this case, even when the number of customers waiting for the payment is small, when the store is crowded, since an immediate rapid increase in the number of customers making a payment is expected, when there is the sales clerk who can participate in the payment operation, the alert of instructing the assembly in the payment operation area is made to cause the sales clerk to be on standby in the payment operation area, and accordingly, it is possible to rapidly deal with the operations, even when the number of customers making a payment is rapidly increased.

The payment service support apparatus according to the embodiment of the invention further includes: an information storage which stores information regarding the alert made by the alert executer; a totalizer which obtains a totalized result relating to occurrence situations of the alerts, based on the information stored in the information storage; and a display information generator which generates display information regarding the occurrence situations of the alerts, based on the totalized result obtained by the totalizer.

In this case, it is possible for a user to simply grasp the occurrence situations of the alerts in the past.

The payment service support apparatus according to the embodiment of the invention further includes: an information storage which stores information regarding a payment waiting state in each detection time point obtained by the payment waiting state detector, information regarding the person-in-store state in each detection time point obtained by the person-in-store state detector, and information regarding the alerts made by the alert executer; and a display information generator which generates display information of combination of temporal transitional situations of the payment waiting customer state, temporal transitional situations of the person-in-store state, and occurrence situations of the alerts, based on the information items stored in the information storage.

In this case, it is possible for a user to grasp timing in which the alert has occurred, by comparison with the temporal transitional situations of the payment waiting customer state or the temporal transitional situations of the person-in-store state.

A payment service support system according to the embodiment of the invention supports payment service in a store so as to decrease customer's waiting time for payment, based on an image obtained by imaging the inside of the store. The payment service support system includes: cameras which image the inside of a store; and a plurality of information processing apparatuses, and any one of the plurality of information processing apparatuses includes a payment waiting state detector which detects a state of a customer waiting for a payment, based on an image obtained by imaging a payment waiting area where customers waiting at a cash register for a payment stay, a person-in-store state detector which detects a state of persons staying in the store, based on an image obtained by imaging the inside of the store, an alert determinator which determines advisability of an alert instructing an action to decrease the customer's waiting time for the payment, based on the detected result of the payment waiting state detector and the detected result of the person-in-store state detector, and an alert executer which makes the alert, based on the determined result of the alert determinator.

In this case, it is possible to optimize the timing of the alert of instructing the sales clerk to perform the action to decrease the customer's waiting time for the payment, and to decrease the unnecessary alerts.

There is provided a payment service support method which causes an information processing apparatus to perform a process of supporting payment service in a store so as to decrease customer's waiting time for payment based on an image obtained by imaging the inside of the store, the method including: a step of detecting a state of a customer waiting for a payment, based on an image obtained by imaging a payment waiting area where customers waiting at a cash register for a payment stay; a step of detecting a state of persons staying in the store, based on an image obtained by imaging the inside of the store; a step of determining advisability of an alert instructing an action to decrease the customer's waiting time for the payment, based on the detected result of the payment waiting state detector and the detected result of the person-in-store state detector; and a step of making the alert, based on the determined result of the above steps.

In this case, it is possible to optimize the timing of the alert of instructing the sales clerk to perform the action to decrease the customer's waiting time for the payment, and to decrease the unnecessary alerts.

Hereinafter, the embodiments of the invention will be described with reference to the drawings.

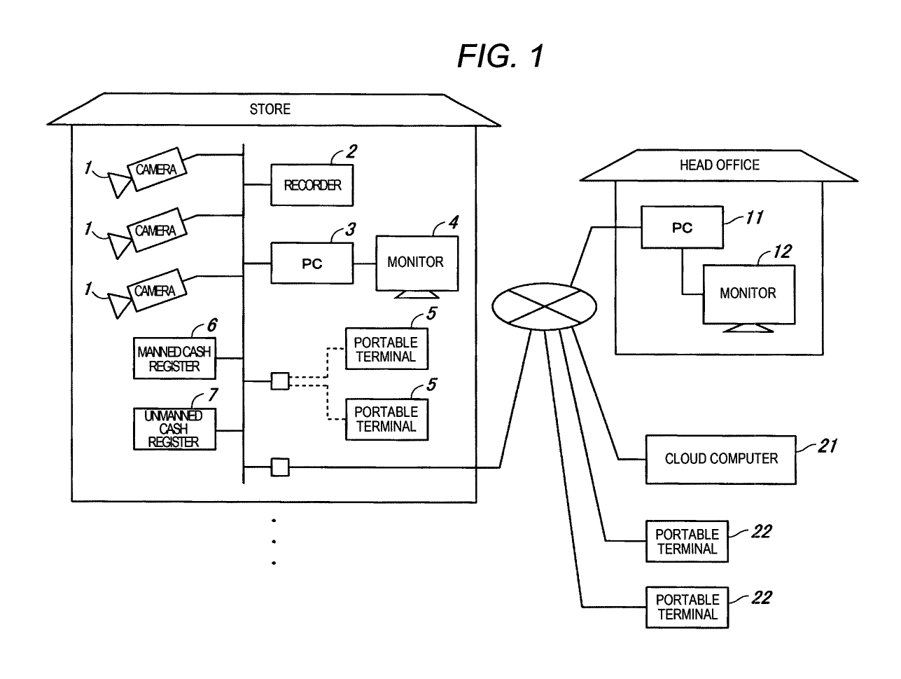

FIG. 1 is an overall configuration diagram of a payment service support system according to the embodiment. The payment service support system is built for a chain of retail stores such as convenience stores, and includes camera (imaging device) 1, recorder (image recording device) 2, PC (payment service support device) 3, monitor (display device) 4, portable terminal 5, manned cash register 6, and unmanned cash register 7 which are provided in each of a plurality of stores, and PC 11 and monitor 12 which are provided in a head office which generally manages the plurality of stores.

Cameras 1 are installed in appropriate places in the store, the inside of the store is imaged by cameras 1, and the image obtained is recorded in recorder 2. In PC 3 installed in the store or PC 11 installed in the head office, it is possible to browse the image of the inside of the store imaged by cameras 1 in real time, it is possible to browse the image of the inside of the store in the past recorded in recorder 2, and therefore, it is possible to check the situation in the store, in the store or in the head office.

PC 3 installed in the store is configured as a payment service support device which supports payment service in a store so as to decrease customer's waiting time for payment. In PC 3, alerting of instructing an action to decrease the customer's waiting time for payment is performed, and a portable terminal (tablet terminal or smart phone) carried by a sales clerk or a store manager is configured as an output device of the alert. Information regarding an occurrence situation of an alert or a payment operation situation in the store is generated by PC 3. It is possible to browse the information generated by PC 3 in PC 3, and it is also possible to browse the information in PC 11 by transmitting the information to PC 11 installed in the head office. PC 3 and PC 11 are configured as a browsing device which browses information regarding the occurrence situation of the alert or the payment operation situation.

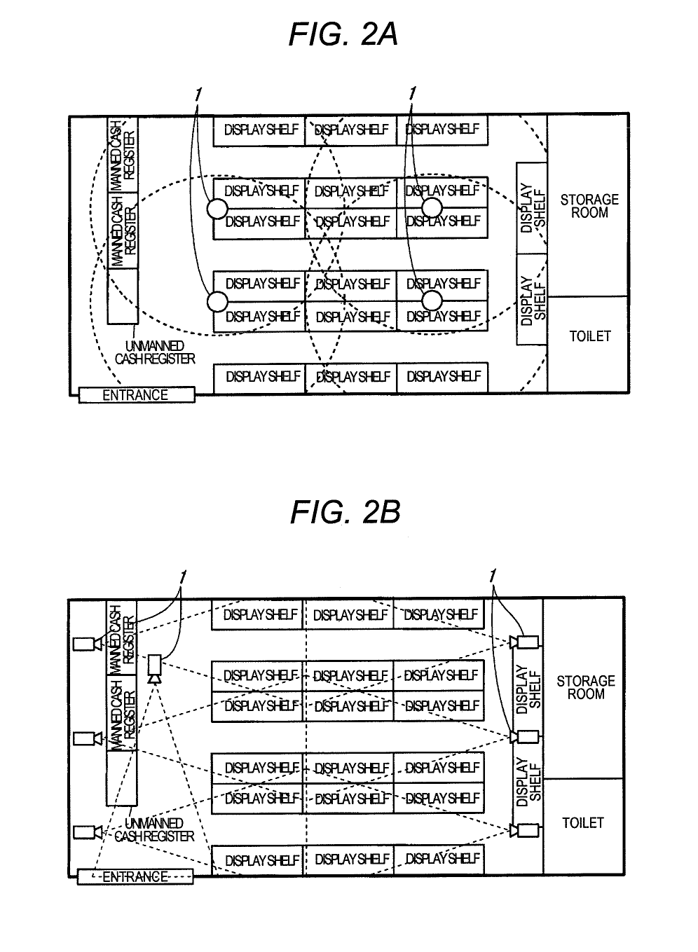

Next, a layout of the store and an installation state of cameras 1 will be described using a convenience store as an example. FIGS. 2A and 2B are plan views of a store illustrating the layout of the store and the installation state of cameras 1.

In the store, the display shelves are installed to be divided into types of products such as a lunch box, processed food, snack food, cup noodles, household goods, and the like. In the store, manned cash registers 6 and unmanned cash register 7 for performing payment of the customer are installed in the store. Manned cash registers 6 are operated by the sales clerk who receives products from the customer to perform the payment operation, and unmanned cash register 7, which is a so-called self cash register, is operated by the customer himself or herself to perform the payment operation.

A storage room and a toilet are provided in the store, in a state of being separated from the selling area having the display shelves provided therein, by a wall.

The plurality of cameras 1 which image the inside of the store are installed in the store. Particularly, in the example shown in FIG. 2A, an omnidirectional camera including an imaging range at 360 degrees using a fisheye lens is employed as camera 1, and in the example shown in FIG. 2B, a camera including a predetermined angle of view that is a so-called box camera is employed as camera 1. These cameras 1 are installed in a ceiling of the store, and can image the customers waiting for the payment at manned cash registers 6 and unmanned cash register 7 or the customers and sales clerks staying in the passages between the display shelves.

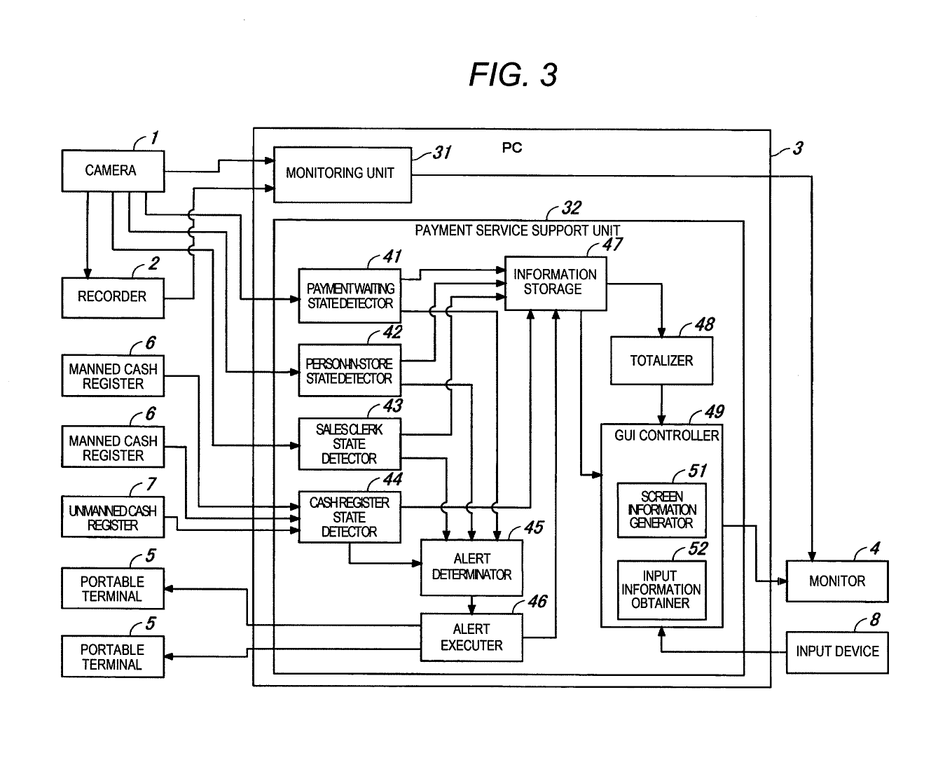

Next, an outline of a payment service support process performed by PC 3 installed in the store shown in FIG. 1 will be described. FIG. 3 is a functional block diagram showing a schematic configuration of PC 3 installed in the store.

PC 3 includes monitoring unit 31 and payment service support unit 32. Management unit 31 causes PC 3 to function as a monitoring system which monitors the inside of the store. Monitoring unit 31 can control the operations of cameras 1 and recorder 2, can browse the image of the inside of the store imaged by cameras 1 in real time, and can browse the image of the inside of the store recorded by recorder 2.

Payment service support unit 32 supports the payment service in the store so as to decrease the customer's waiting time for payment, based on the image obtained by imaging the inside of the store by camera 1, and includes payment waiting state detector 41, person-in-store state detector 42, sales clerk state detector 43, cash register state detector 44, alert determinator 45, alert executer 46, information storage 47, total unit 48, and GUI controller 49.

Payment waiting state detector 41 performs a process of detecting the state of the customers waiting for payment, based on the image obtained by imaging a payment waiting area where the customers waiting for payment at manned cash registers 6 and unmanned cash register 7 stay by cameras 1. In the embodiment, the persons staying in the payment waiting area are detected from the image of the payment waiting area, and the number of persons staying in the payment waiting area, that is, the number of customers waiting for the payment (number of persons waiting for the payment) is measured, based on the detected result of the person detection process. This measurement process of the number of persons waiting for the payment is performed for each of manned cash registers 6 and unmanned cash register 7, and the number of persons waiting for the payment of each of manned cash registers 6 and unmanned cash register 7 is obtained.

Payment waiting state detector 41 determines whether or not there are a lot of customers waiting for the payment at manned cash register 6, based on the number of persons waiting for the payment at manned cash registers 6. The determination of the manned cash register payment waiting state is performed by comparing the number of persons waiting for the payment with a predetermined threshold value, and when the number of persons waiting for the payment at each cash register reaches the threshold value, it is determined that there are a lot of customers waiting for the payment. The threshold value may be suitably set and can be set as 1, and in this case, it is determined that there are a lot of customers waiting for the payment, if the number of customers waiting for the payment is 1.

Person-in-store state detector 42 performs a process of detecting the state of the persons staying in the store, based on the image obtained by imaging the inside of the store by cameras 1. In the embodiment, the persons staying in the store are detected from the image of the inside of the store, the number of persons staying in the store is measured based on the detected results of the person detection process, and it is determined whether or not the store is crowded, based on the number of persons staying in the store. The determination of the crowded store state is performed by comparing the number of persons staying in the store with a predetermined threshold value, and when the number of persons staying in the store reaches the threshold value, it is determined that the store is crowded.

Sales clerk state detector 43 performs a process of detecting the state of the sales clerks staying in the store, based on the image obtained by imaging the inside of the store by cameras 1. In the salesclerk state detection process, the persons staying in the store are detected from the image of the inside of the store, and the sales clerks staying in the store are detected by performing sales clerk determination of determining whether or not the person detected in the person detection process is the sales clerk.

Particularly, sales clerk state detector 43 detects the sales clerk who can newly participate in the payment operation, that is, the sales clerk who stays in the outside of a payment operation area in the store and performs the operation other than the payment operation. Such a sales clerk can perform the operation at the register operation at manned cash register 6 which is newly operated. Particularly, in the embodiment, the sales clerk staying in the selling area is detected as the sales clerk who can newly participate in the payment operation, and the number of sales clerks staying in the selling area is measured.

In the same manner as that of person-in-store state detector 42, it is necessary to perform the person detection process using the inside of the store as a target by sales clerk state detector 43. It is not necessary to separately perform the person detection process by person-in-store state detector 42 and sales clerk state detector 43, and sales clerk state detector 43 may perform the sales clerk determination using the detected results of the person detection process performed by person-in-store state detector 42. When camera 1 is the omnidirectional camera, it is difficult to image the face of the sales clerk from the front, and accordingly, the sales clerk determination may be performed based on characteristics of clothes. Meanwhile, when camera 1 is the box camera, it is possible to image the face of the sales clerk from the front. Accordingly, it is possible to perform the sales clerk determination face collation, and both of the face collation and the clothes determination may be performed.

For the person detection process performed by payment waiting state detector 41, person-in-store state detector 42, and sales clerk state detector 43, a well-known image recognition technology, that is, a technology of extracting an image of a person from an image to obtain a position of the person, may be used.

Cash register state detector 44 performs a process of detecting usage states of manned cash registers 6 and unmanned cash register 7 and the operation state of manned cash registers 6. In the cash register state detection process, status information is obtained from manned cash registers 6 and unmanned cash register 7, and determination regarding the cash register usage state of whether or not manned cash registers 6 and unmanned cash register 7 are in use, and determination regarding the operation state of whether each of plurality of manned cash registers 6 are in operation or stopped are performed based on the status information.

In the embodiment, the expression that manned cash registers 6 and unmanned cash register 7 are in use, means that manned cash registers 6 and unmanned cash register 7 are started up (turned on) to be in a usable state. The expression that manned cash register 6 is stopped, means a state where a counter of manned cash register 6 is temporarily closed, that is, specifically, a board indicating the closed counter is loaded on the counter so as not to perform the payment at manned cash register 6, and this does not necessarily mean the stopping of manned cash register 6.

Each detection process performed by payment waiting state detector 41, person-in-store state detector 42, sales clerk state detector 43, and cash register state detector 44 is performed at predetermined intervals (for example, intervals of 5 minutes). The detection result including the number of persons waiting for the payment is output from payment waiting state detector 41 at every detection time point, the detection result including the number of persons staying in the store is output from person-in-store state detector 42 at every detection time point, the detection result including the number of sales clerks in the selling area is output from sales clerk state detector 43 at every detection time point, and the information regarding the usage state and the operation state is output from cash register state detector 44 at every detection time point.

Alert determinator 45 performs a process of determining advisability of an alert instructing an action to decrease the customer's waiting time for the payment, based on the detected results of payment waiting state detector 41, person-in-store state detector 42, sales clerk state detector 43, and cash register state detector 44.

In the embodiment, an alert of instructing the operation of manned cash register 6 being stopped (manned cash register operation alert), an alert of instructing guidance recommending using unmanned cash register 7 to the customer waiting for the payment at manned cash register 6 (unmanned cash register guidance alert), an alert instructing the support of the payment operation at manned cash register 6, that is, assistance operation such as a bagging operation (cash register support alert), an alert instructing assembly in the payment operation area for an input operation or the assistance operation at manned cash register 6 (cash register assembly alert), and an alert indicating that manned cash register 6 can be stopped (cash register stop alert) are made.

As described above, in the embodiment, payment waiting state detector 41 performs detection of the manned cash register payment waiting state of whether or not there are a lot of customers waiting for the payment at manned cash register 6 and detection of the unmanned cash register payment waiting state of whether or not there is a customer's waiting for the payment at unmanned cash register 7, person-in-store state detector 42 performs detection of the crowded store state of whether or not the store is crowded, sales clerk state detector 43 performs detection of a selling area sales clerk state of whether or not the sales clerk stays in the selling area, cash register state detector 44 performs detection of the cash register usage state and the operation state of manned cash registers 6 and unmanned cash register 7, and the necessary type of the alert is determined based on these detected results.

Alert executer 46 makes an alert instructing the action to decrease the customer's waiting time for the payment to the sales clerk or the store manager, based on the determined result of alert determinator 45. This alert is made using portable terminal (tablet terminal or smart phone) 5 carried by the sales clerk or the store manager, the information regarding the alert contents is transmitted from alert executer 46 to portable terminal 5, and an alert screen displaying the alert contents is displayed on portable terminal 5.

The information regarding the number of persons waiting for the payment obtained by payment waiting state detector 41 at every detection time point, the information regarding the number of persons staying in the store obtained by person-in-store state detector 42 at every detection time point, the information regarding the number of sales clerk in the selling area obtained by sales clerk state detector 43 at every detection time point, the information regarding the operation states of manned cash registers 6 and unmanned cash register 7 obtained by cash register state detectior 44 at every detection time point, and the alert result, that is, the information regarding the occurrence time point and the type of the alert obtained by alert executer 46, are stored in information storage 47.

Totalizer 48 performs a process of obtaining the total result regarding the occurrence situation of the alert, based on the information regarding the occurrence time point and the type of the alert stored in information storage 47. In the embodiment, totalizer 48 performs a process of totalizing the occurrence time points of the alert in a predetermined total unit period to obtain the number of times of alerting in each predetermined total unit period.

GUI controller 49 performs a process of obtaining input information by an input operation by a user, by a graphical user interface (GUI) using monitor 4 and input device (input unit) 8 such as a mouse, and an operation of outputting information regarding the occurrence situation of the alert or the payment operation situation, and includes screen information generator (display information generator) 51 and input information obtainer 52.

Screen information generator 51 performs a process of generating display information regarding a display screen displaying the information regarding the occurrence situation of the alert or the payment operation situation, and the display screen is displayed on monitor 4. Input information obtainer 52 performs a process of obtaining input information according to an input operation performed by a user on the screen displayed on monitor 4 using input device 8. A process of setting process conditions by payment service support unit 32 is performed based on the input information obtained by input information obtainer 52.

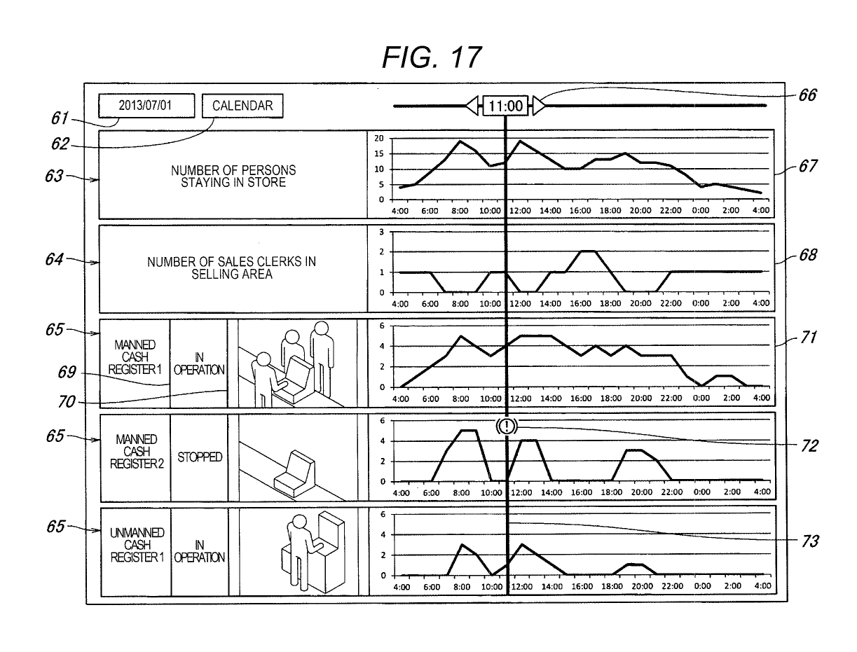

Particularly, screen information generator 51 performs a process of generating the display information regarding a payment operation situation display screen (see FIGS. 17 to 19) displaying combination of temporal transitional situations of the person-in-store state (number of persons staying in the store), the sales clerk state (number of sales clerks in the selling area), and the payment waiting state (number of customers waiting at the cash register for the payment), and the occurrence situation of the alert in a predetermined target period, based on the information items obtained by payment waiting state detector 41, person-in-store state detector 42, sales clerk state detector 43, and cash register state detector 44 and the information regarding the alert result obtained by alert executer 46, and the payment operation situation display screen is displayed on monitor 4.

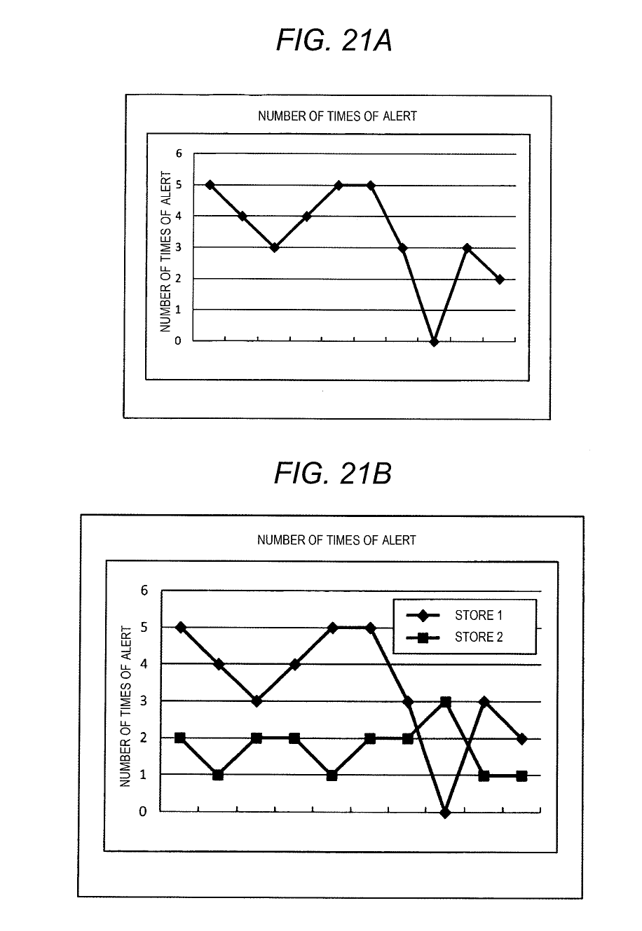

Screen information generator 51 performs a process of generating display information regarding an alert situation display screen (see FIG. 21) displaying the number of times of alerting in each total unit period in the predetermined target period, based on the information regarding the total result obtained by totalizer 48, and this alert situation display screen is displayed on monitor 4.

Monitoring unit 31 and payment service support unit 32 include a processor (CPU) and a program memory. The CPU of PC 3 is realized by executing programs (instructions) for monitoring and payment service support. The programs may be introduced to PC 3 as an information processing apparatus in advance to configure PC as a dedicated apparatus, or may be supplied to a user by being recorded in a suitable program recording medium as an application program to be operated on a general-use OS, or through a network.

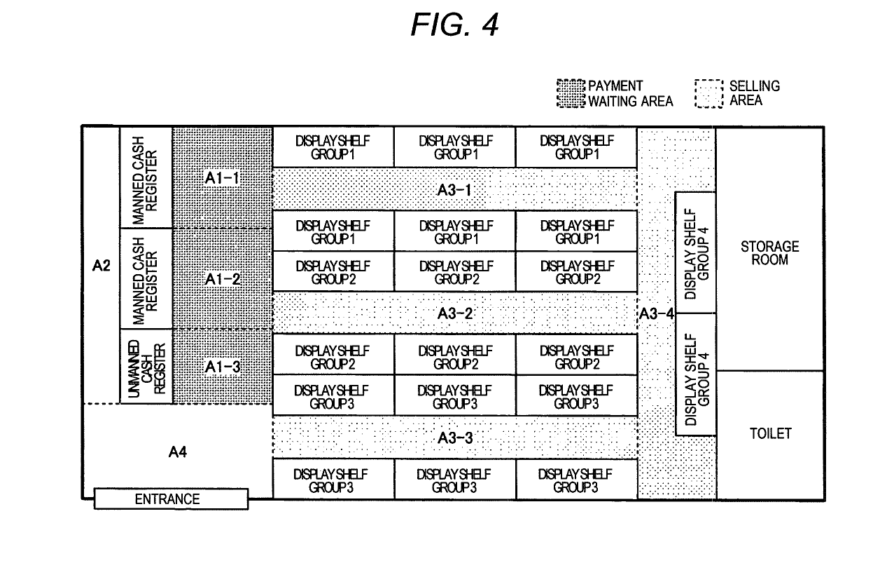

Next, various areas set in the store will be described. FIG. 4 is an explanatory diagram showing various areas set in the store.

A customer enters the store from the entrance, moves in the store through passages between the display shelves, and makes a payment at manned cash register 6 or unmanned cash register 7 by bringing a product, when a desired product is found. Herein, the customer stays in front of manned cash register 6 or unmanned cash register 7 when making a payment. In the embodiment, in order to detect the state of the customer who makes a payment, payment waiting areas A1-1 to A1-3 are set in an area in front of manned cash register 6 or unmanned cash register 7.

Herein, in the embodiment, as described above, payment waiting state detector 41 measures the number of customers waiting for the payment for each of manned cash registers 6 and unmanned cash register 7, but in this payment waiting state detection process, it is possible to measure the number of customers waiting for the payment for each of manned cash registers 6 and unmanned cash register 7, by detecting the number of persons staying in each of payment waiting areas A1-1 to A1-3.

Payment operation area A2 where the sales clerk stays for performing the payment operation is set on a side opposite to payment waiting areas A1-1 to A1-3 with manned cash registers 6 and unmanned cash register 7 interposed therebetween. Passage areas A3-1 to A3-4, where customers or sales clerks stay, are set between the display shelves of the selling area. An entrance area A4 is set on the side of the selling area of the entrance of the store.

Herein, in the embodiment, person-in-store state detector 42 measures the number of persons staying in the store, and a target area in this person-in-store state detection process is set as the entire store. However, since the number of persons staying in the store is for grasping the crowded state of the customers, the payment operation area A2 where only the sales clerks stay, may be excluded, or the selling point, that is, only the passage areas A3-1 to A3-4, may be set.

In the embodiment, sales clerk state detector 43 measures the number of sales clerks staying in the selling area, that is, the passage areas A3-1 to A3-4, but the target area in this sales clerk state detection process may include the entrance area A4.

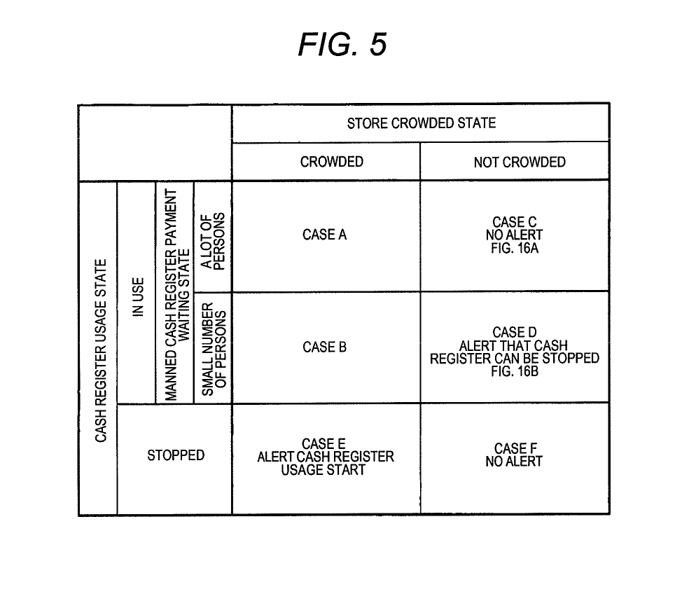

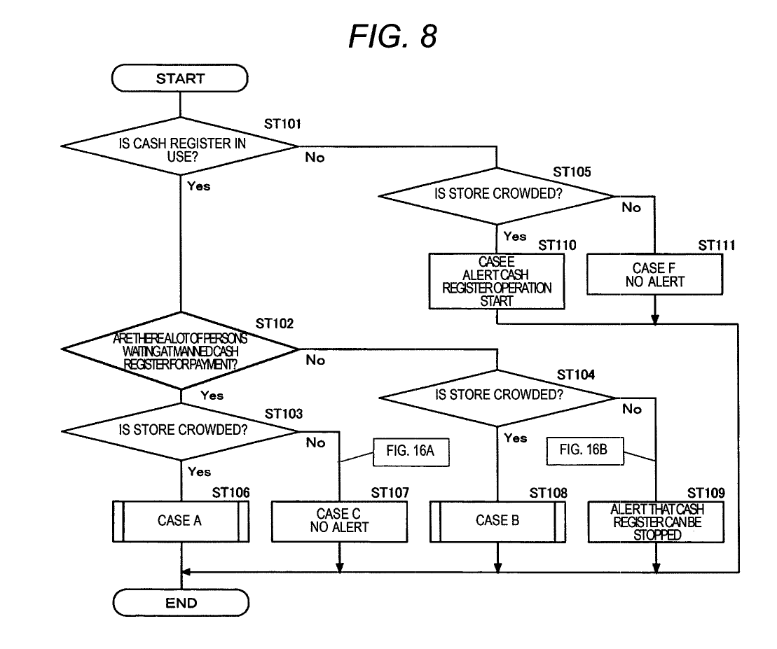

Next, an alert determination process performed by alert determinator 45 shown in FIG. 1 will be described. FIGS. 5, 6, and 7 are explanatory diagrams illustrating an outline of the alert determination process performed by alert determinator 45. FIGS. 8, 9, and 10 are flowcharts illustrating procedures of the alert determination process performed by alert determinator 45.

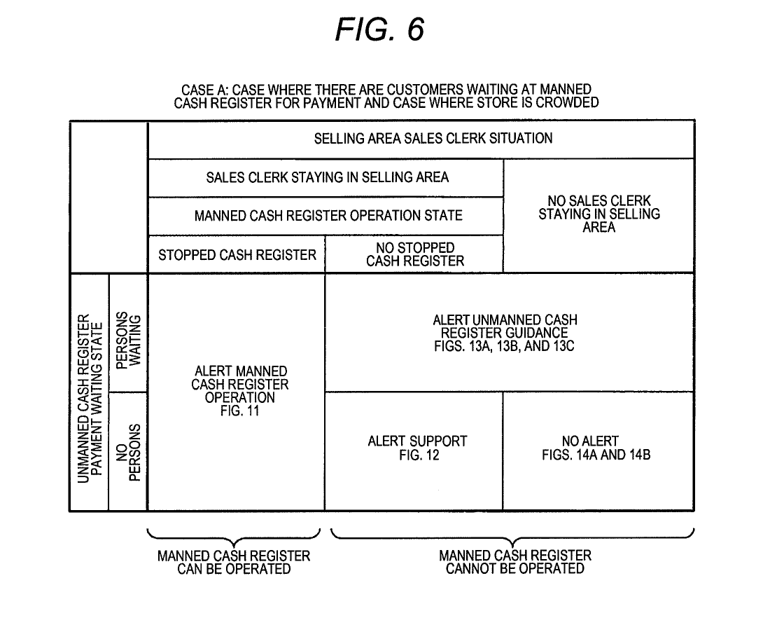

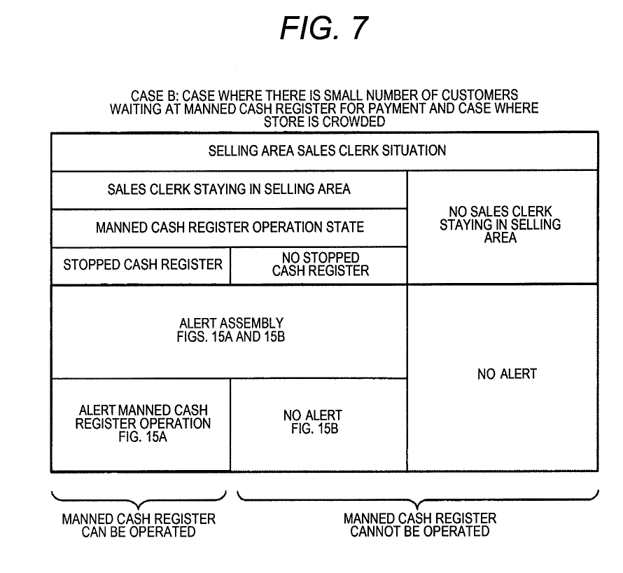

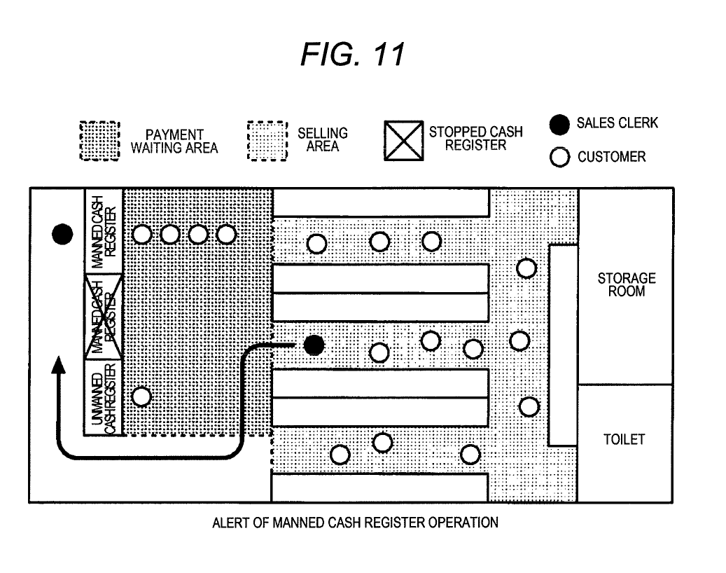

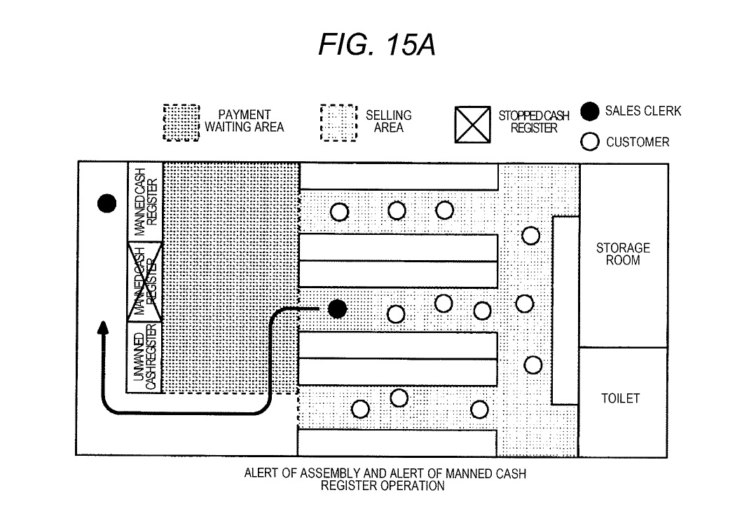

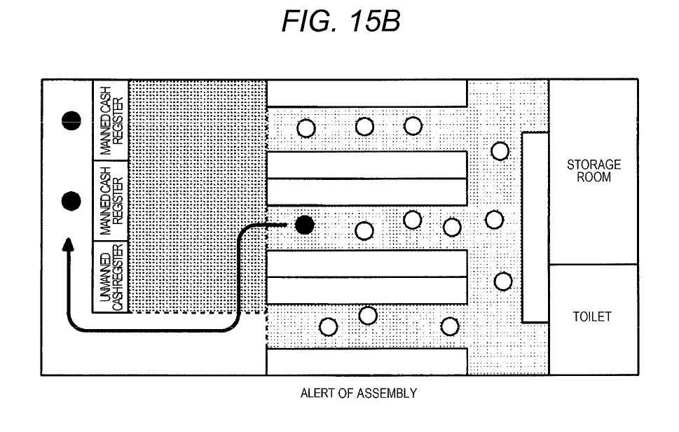

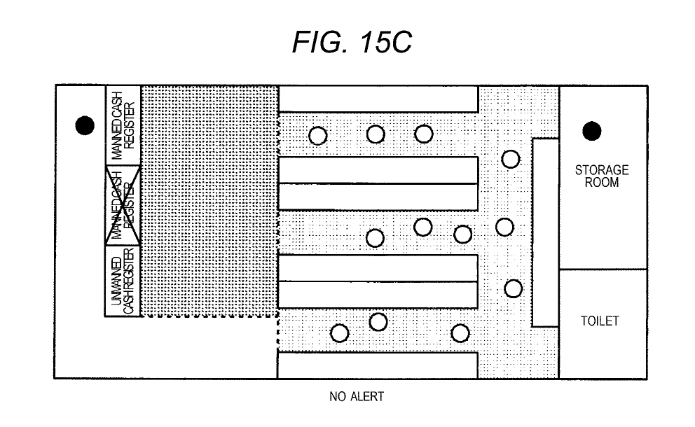

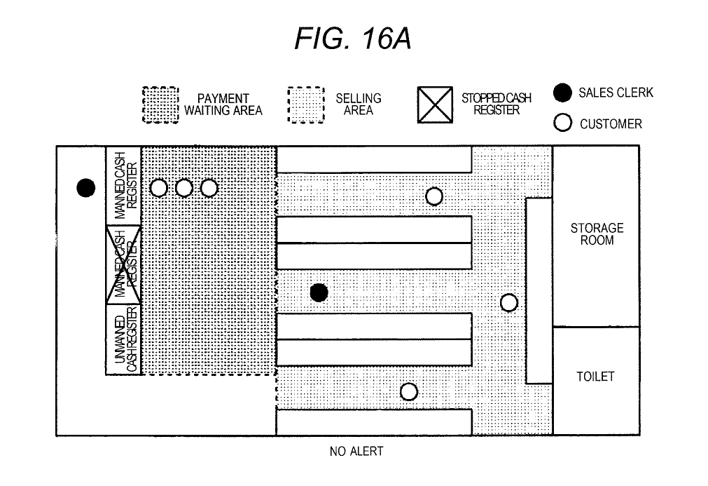

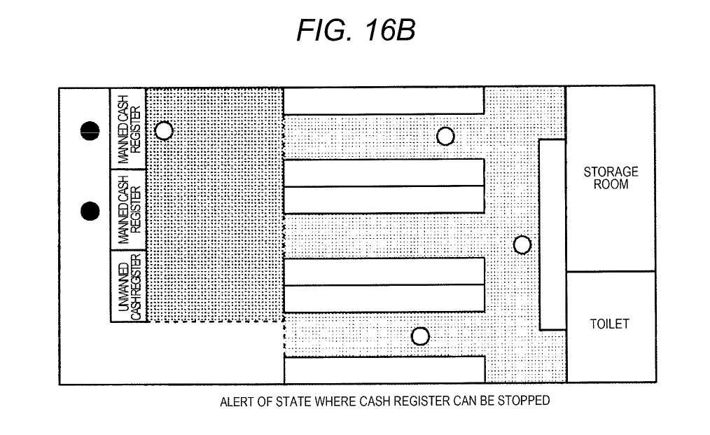

FIGS. 11, 12, 13A, 13B, 13C, 14A, and 14B are explanatory diagrams illustrating situations in the store of a case A shown in FIG. 6. FIGS. 15A, 15B, and 15C are explanatory diagrams illustrating situations in the store of a case B shown in FIG. 7. FIGS. 16A and 16B are explanatory diagrams illustrating situations in the store of cases C and D shown in FIG. 5.

As shown in FIG. 5, alert determinator 45 performs determination of cash register usage state (ST101 of FIG. 8), determination of the manned cash register payment waiting state (ST102 of FIG. 8), and determination of crowded store state (ST103, ST104, and ST105 of FIG. 8), and accordingly, the cases are divided into six cases A to F.

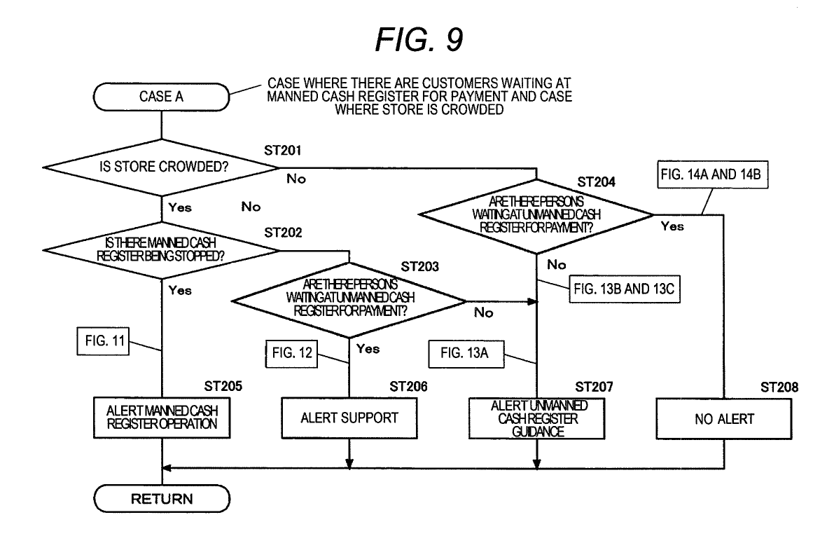

As shown in FIG. 6, in a case of the case A shown in FIG. 5, that is, when manned cash registers 6 and unmanned cash register 7 are in use (Yes in ST101 of FIG. 8), when there are a lot of customers waiting for the payment at manned cash register 6 (Yes in ST102 of FIG. 8), and when the store is crowded (Yes in ST103 of FIG. 8), alert determinator 45 performs determination of the selling area sales clerk state (ST201 of FIG. 9), determination of the manned cash register operation state (ST202 of FIG. 9), and determination of the unmanned cash register waiting state (ST203 and ST204 of FIG. 9).

Herein, as shown in FIG. 11, when the sales clerk stays in the selling area (Yes in ST201 of FIG. 9) and when there is manned cash register 6 being stopped (Yes in ST202 of FIG. 9), it is determined that manned cash registers 6 can newly be operated, and the alert of instructing the operation of manned cash register 6 being stopped (manned cash register operation alert) is made (ST205 of FIG. 9). When the sales clerk staying in the selling area checks this alert, the sales clerk operates manned cash register 6 being stopped and performs the payment operation (register input operation) at manned cash register 6.

Meanwhile, when there is no sales clerks staying in the selling area (No in ST201 of FIG. 9) or when all of manned cash registers 6 are already operated (No in ST202 of FIG. 9), it is determined that it is difficult to newly operate manned cash registers 6, and as will be described later, the alert other than the manned cash register operation alert is made or no alerts are made.

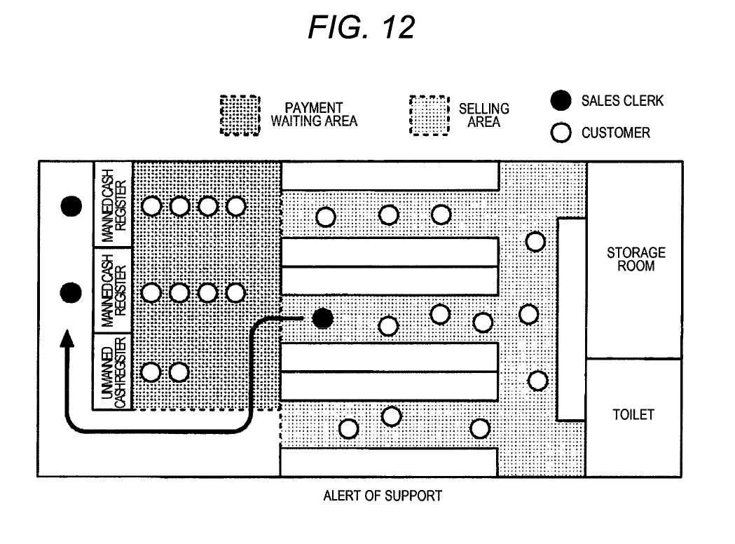

That is, as shown in FIG. 12, when the sales clerk stays in the selling area (Yes in ST201 of FIG. 9), when all of manned cash registers 6 are already operated (No in ST202 of FIG. 9), and when there is the customer waiting at unmanned cash register 7 for the payment (Yes in ST203 of FIG. 9), the alert instructing the support of the payment operation at manned cash register 6 (cash register support alert) is made (ST206 of FIG. 9). When the sales clerk staying in the selling area checks this alert, the sales clerk moves to the cash register operation area and performs the assistance operation such as a bagging operation.

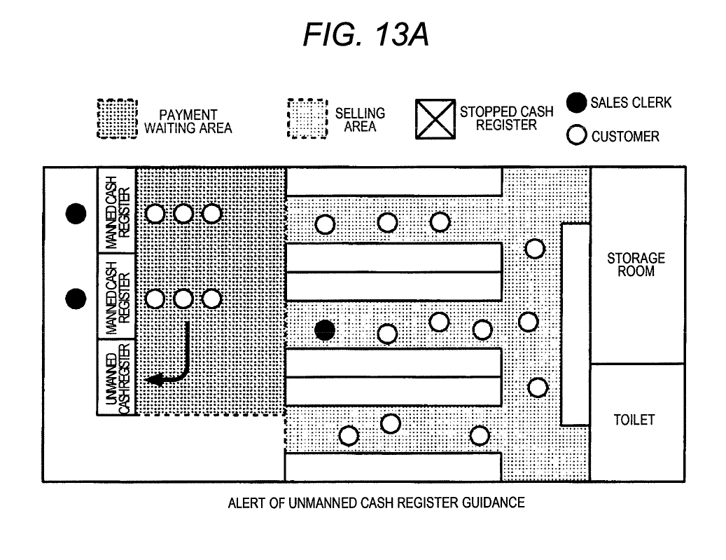

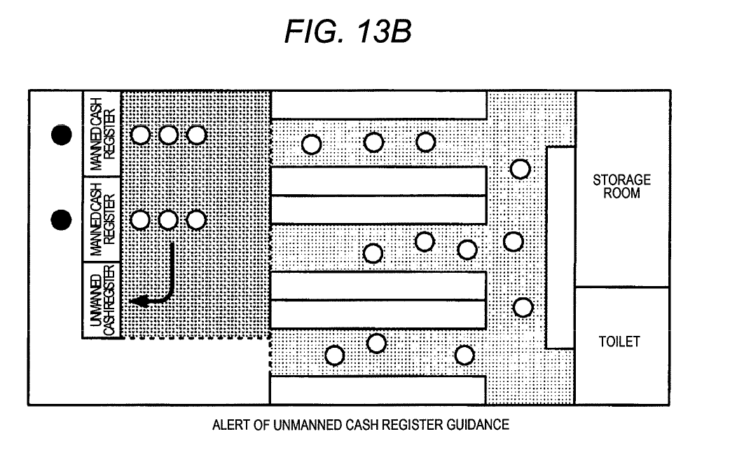

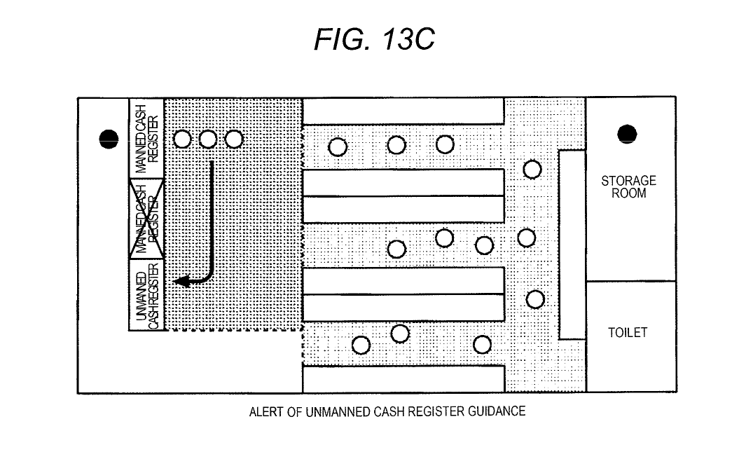

As shown in FIG. 13A, when the sales clerk stays in the selling area (Yes in ST201 of FIG. 9), when all of manned cash registers 6 are already operated (No in ST202 of FIG. 9), and when there is no customer waiting for the payment at unmanned cash register 7 (No in ST203 of FIG. 9), an alert of instructing guidance recommending using unmanned cash register 7 to the customer waiting at manned cash register 6 for the payment (unmanned cash register guidance alert) is made (ST207 of FIG. 9). When the sales clerk staying in this selling area and the sales clerk performing the payment operation at manned cash register 6 check this alert, the sales clerk performs guidance recommending using unmanned cash register 7 the customer waiting at manned cash register 6 for the payment.

As shown in FIGS. 13B and 13C, when there is no sales clerks staying in the selling area (No in ST201 of FIG. 9) and when there is no customer waiting at unmanned cash register 7 for the payment (No in ST204 of FIG. 9), the alert of instructing guidance recommending using unmanned cash register 7 to the customer waiting at manned cash register 6 for the payment (unmanned cash register guidance alert) is made (ST207 of FIG. 9). When the sales clerk performing the payment operation at manned cash register 6 checks this alert, the sales clerk performs guidance recommending using unmanned cash register 7 to the customer waiting at manned cash register 6 for the payment.

Herein, in an example shown in FIG. 13B, since all of manned cash registers 6 are already operated, it is difficult to newly operate manned cash registers 6. In an example shown in FIG. 13C, although there is manned cash register 6 being stopped, another sales clerk performs an operation in the storage room so that there is no sales clerk staying in the selling area, that is, there is no sales clerk performing the payment operation at manned cash register 6, and accordingly, it is difficult to operate manned cash register 6 being stopped.

When unmanned cash register 7 is stopped, an alert instructing the operation of unmanned cash register 7 (unmanned cash register operation alert) is made in combination with the unmanned cash register guidance alert.

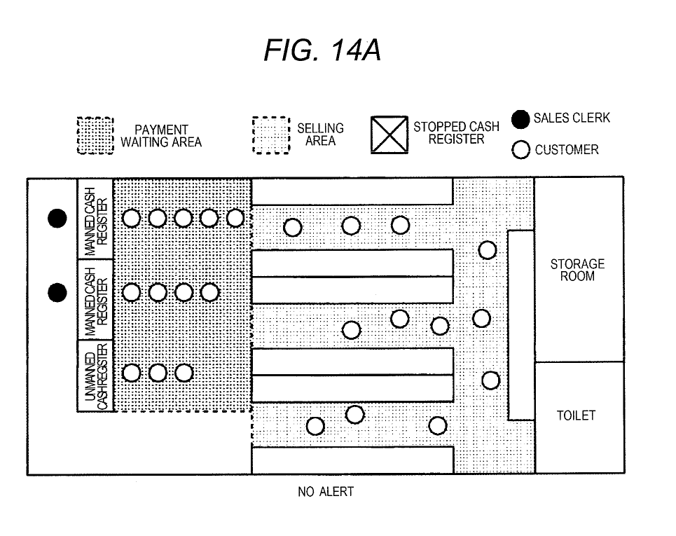

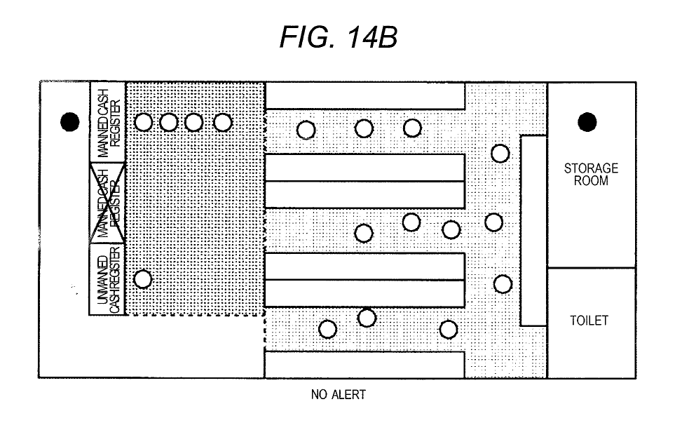

As shown in FIGS. 14A and 14B, when there is no sales clerk staying in the selling area (No in ST201 of FIG. 9) and when there is the customer waiting at unmanned cash register 7 for the payment (Yes in ST204 of FIG. 9), no alerts are made (ST208 of FIG. 9).

Herein, in an example shown in FIG. 14A, since all of manned cash registers 6 are already operated, it is difficult to newly operate manned cash registers 6. In an example shown in FIG. 14B, although there is manned cash register 6 being stopped, another sales clerk performs an operation in the storage room so that there is no sales clerk staying in the selling area, that is, there is no sales clerk performing the payment operation at manned cash register 6, and accordingly, it is difficult to operate manned cash register 6 being stopped.

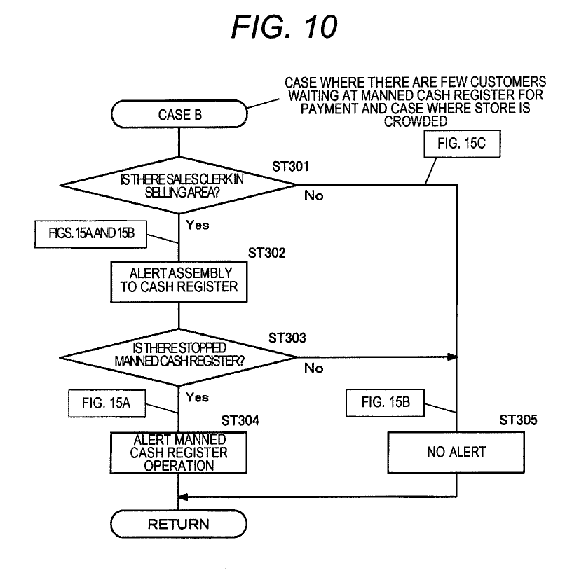

As shown in FIG. 7, in a case of the case B shown in FIG. 5, that is, when cash registers are in use (Yes in ST101 of FIG. 5), when there is the small number of customers waiting at manned cash registers 6 for the payment (No in ST102 of FIG. 5), and when the store is crowded (Yes in ST104 of FIG. 5), alert determinator 45 performs determination of the selling area sales clerk state (ST301 of FIG. 10) and determination of the manned cash register operation state (ST303 of FIG. 10).

Herein, as shown in FIGS. 15A and 15B, when the sales clerk stays in the selling area (Yes in ST301 of FIG. 10), an alert of instructing the assembly in the cash register operation area (cash register assembly alert) is made (ST302 of FIG. 10). When the sales clerk staying in the selling area checks this alert, the sales clerk moves to the payment operation area.

As shown in FIG. 15A, when there is manned cash register 6 being stopped (Yes in ST303 of FIG. 10), it is determined that manned cash registers 6 can newly be operated, and the alert of instructing the operation of manned cash register 6 being stopped (manned cash register operation alert) is made (ST304 of FIG. 10). When the sales clerk who has moved to the payment operation area checks this alert, the sales clerk operates manned cash register 6 being stopped and performs the payment operation (register input operation) at manned cash register 6.

Meanwhile, as shown in FIG. 15B, when all of manned cash registers 6 are already operated (No in ST303 of FIG. 7), no alerts are made (ST305 of FIG. 10). In this case, the sales clerk on standby in the payment operation area according to the cash register assembly alert performs the assistance operation such as a bagging operation.

As shown in FIG. 15C, when there is no sales clerk staying in the selling area (No in ST301 of FIG. 10), no alerts are made (ST305 of FIG. 10). In an example shown in FIG. 15C, although there is manned cash register 6 being stopped, another sales clerk performs an operation in the storage room so that there is no sales clerk staying in the selling area, that is, there is no sales clerk performing the payment operation at manned cash register 6, and accordingly, it is difficult to operate manned cash register 6 being stopped.

As shown in FIG. 16A, in a case of the case C shown in FIG. 5, that is, when cash registers are in use (Yes in ST101 of FIG. 8), when there are a lot of customers waiting at manned cash registers 6 for the payment (Yes in ST102 of FIG. 8), and when the store is not crowded (No in ST103 of FIG. 8), no alerts are made (ST107 of FIG. 8). In an example shown in FIG. 16A, it is possible to newly operate manned cash register 6, but since the store is not crowded, a possibility of the increase of the number of customers waiting for the payment is low, and the necessity of performing the alert such as manned cash register operation alert is low.

As shown in FIG. 16B, in a case of the case D shown in FIG. 5, that is, when cash registers are in use (Yes in ST101 of FIG. 8), when there is the small number of customers waiting at manned cash registers 6 for the payment (No in ST102 of FIG. 8), and when the store is not crowded (No in ST104 of FIG. 5), an alert indicating that manned cash register 6 can be stopped (cash register stop alert) is made (ST109 of FIG. 8).

As shown in FIG. 5, in a case of the case E, that is, when manned cash registers 6 and unmanned cash register 7 are out of use (No in ST101 of FIG. 8) and when the store is crowded (Yes in ST105 of FIG. 8), the alert of instructing start of the usage of manned cash registers 6 and unmanned cash register 7 (cash register usage start alert) is made (ST110 of FIG. 8). Meanwhile, in a case of the case F, that is, when manned cash registers 6 and unmanned cash register 7 are out of use (No in ST101 of FIG. 8) and when the store is not crowded (No in ST105 of FIG. 8), no alerts are made (ST111 of FIG. 8).

As the determination regarding the payment waiting state, it is determined whether or not there are a lot of customers waiting at manned cash register 6 for the payment, but this determination is performed by comparison with the predetermined threshold value as described above. This threshold value may be suitably set, and for example, the determination may be performed by setting the threshold value as 1, that is, the determination whether or not there is the customer waiting at manned cash register 6 for the payment may be performed. It is determined whether or not there are customers waiting at unmanned cash register 7 for the payment, but the determination whether or not there are a lot of customers waiting for the payment may be performed by comparison with the predetermined threshold value, in the same manner as in manned cash register 6.

Next, the payment operation situation display screen displayed on monitor 4 of the store and monitor 12 of the head office shown in FIG. 1 will be described. FIGS. 17, 18, and 19 are explanatory diagrams showing the payment operation situation display screen displayed on monitor 4 of the store or monitor 12 of the head office.

In examples shown in FIGS. 17 to 19, the payment operation situation of the past, that is, before the previous day, is displayed on the payment operation situation display screen, but it is possible to display this payment operation situation display screen in real time. In this case, only the range of the past, that is, only the range of the time point before the current time point, is displayed.

The payment operation situation display screen displays combination of temporal transitional situations of the person-in-store state (number of persons staying in the store), the sales clerk state (number of sales clerks in the selling area), and the payment waiting state (number of customers waiting at the cash register for the payment), and the occurrence situation of the alert in the predetermined target period (1 day herein), and the payment operation situation display screen is provided with date display part 61, calendar button 62, person-in-store state display part 63, sales clerk state display part 64, payment waiting state display part 65, and display time point operation part 66.

Date display part 61 displays the date and calendar button 62 is for selecting the date. When calendar button 62 is operated, a calendar screen (not shown) is displayed, and by selecting the date herein, the selected date is displayed on date display part 61, and the payment operation situation of the selected date is displayed on person-in-store state display part 63, sales clerk state display part 64, and payment waiting state display part 65.

Person-in-store state display part 63 is provided with graph display part 67, and the temporal transitional situations of the number of persons staying in the store are displayed in graph display part 67 as a graph (line graph). In this graph, a horizontal axis indicates the time zone and a vertical axis indicates the number of persons staying in the store. With this graph, it is possible for a user to grasp the temporal transitional situations of the number of persons staying in the store.

Sales clerk state display part 64 is provided with graph display part 68, and the temporal transitional situations of the number of sales clerk in the selling area are displayed in graph display part 68 as a graph (line graph). In this graph, a horizontal axis indicates the time zone and a vertical axis indicates the number of sales clerk in the selling area. With this graph, it is possible for a user to grasp the temporal transitional situations of the number of sales clerk in the selling area.

Payment waiting state display part 65 is provided for each of two manned cash registers 6 and unmanned cash register 7, and payment waiting state display part 65 is provided with cash register operation situation display part 69, image display part 70, and graph display part 71. The operation situation (in operation or stopped) of manned cash registers 6 and unmanned cash register 7 is displayed on cash register operation situation display part 69. The image of the payment operation area or the payment waiting area, that is, the image having the sales clerk performing the payment operation, the customer making the payment, and the customer waiting for the payment is displayed on image display part 70.

The temporal transitional situations of the number of persons waiting for the payment are displayed on graph display part 71 as a graph (line graph). In this graph, a horizontal axis indicates the time zone and a vertical axis indicates the number of persons waiting for the payment. With this graph, it is possible for a user to grasp the temporal transitional situations of the number of persons waiting for the payment.

Alert mark 72 showing the occurrence time point of the alert is displayed on graph display part 71. Accordingly, it is possible for a user to grasp timing in which the alert has occurred, by comparison with the temporal transitional situations of the number of persons waiting for the payment.

Display time point operation part 66 adjusts the time point of the image displayed on image display part 70. By operating display time point operation part 66, it is possible to switch the image to an image at the desired time point. Specifically, display time point operation part 66 is provided to be movable in a direction along the horizontal axis (time axis) of the graph displayed on graph display parts 67, 68, and 71, and when display time point operation part 66 is moved using input device 8 such as a mouse, a line 73 displayed on graph display parts 67, 68, and 71 moves and the image at the time point indicated by line 73 is displayed on image display part 70. Accordingly, it is possible to check the occurrence time point of the alert or the actual state of the payment operation area and the payment waiting area at the desired time point on the image of image display part 70.

When displaying the payment operation situation display screen shown in FIGS. 17 to 19 in real time, only the left arrow of display time point operation part 66 is displayed and it is possible to display the image backward in time.

Herein, an example shown in FIG. 17 is a case where display time point operation part 66 is matched with the time point when the alert instructing the operation of manned cash register 6 being stopped (manned cash register operation alert) is made. As shown in FIG. 11, the inside of the store in this case is in a state where there are a lot of persons staying in the store, that is, the store is crowded, a state where there are a lot of customers waiting at manned cash register 6 for the payment, a state where the sales clerk stays in the selling area, and a state where there is manned cash register 6 being stopped, and the manned cash register operation alert is made according to the procedure shown in FIG. 9.

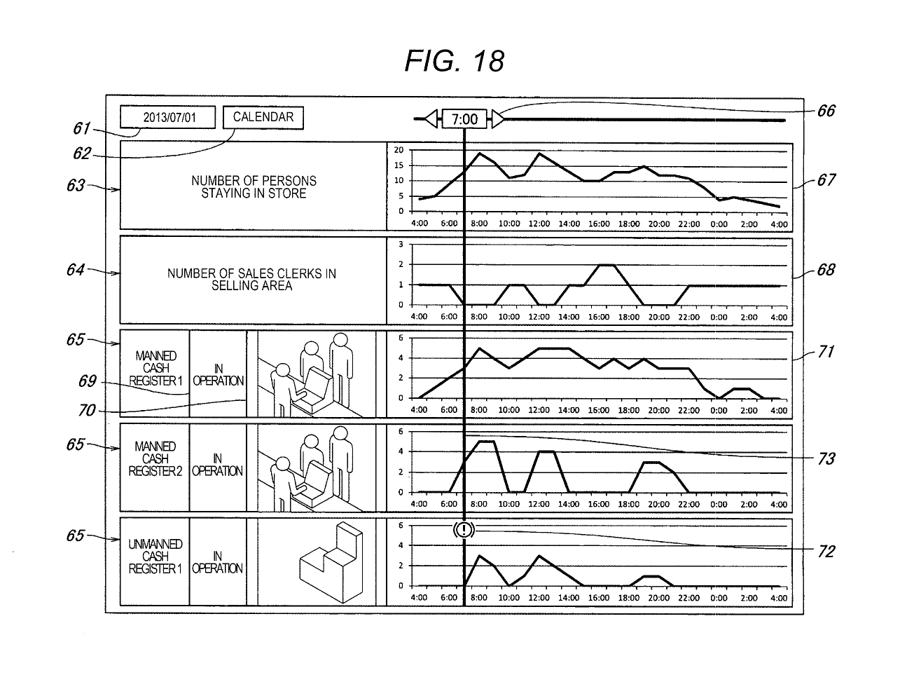

An example shown in FIG. 18 is a case where display time point operation part 66 is matched with the time point when the alert of instructing guidance recommending using unmanned cash register 7 to the customer waiting for the payment at manned cash register 6 (unmanned cash register guidance alert) is made. As shown in FIG. 13B, the inside of the store in this case is in a state where there are a lot of persons staying in the store, that is, the store is crowded, a state where the number of sales clerks in the selling area is 0, that is, there is no sales clerk staying in the selling area, a state where there are a lot of customers waiting at manned cash register 6 for the payment, and a state where there is no customer waiting at unmanned cash register 7 for the payment, and the unmanned cash register guidance alert is made according to the procedure shown in FIG. 9.

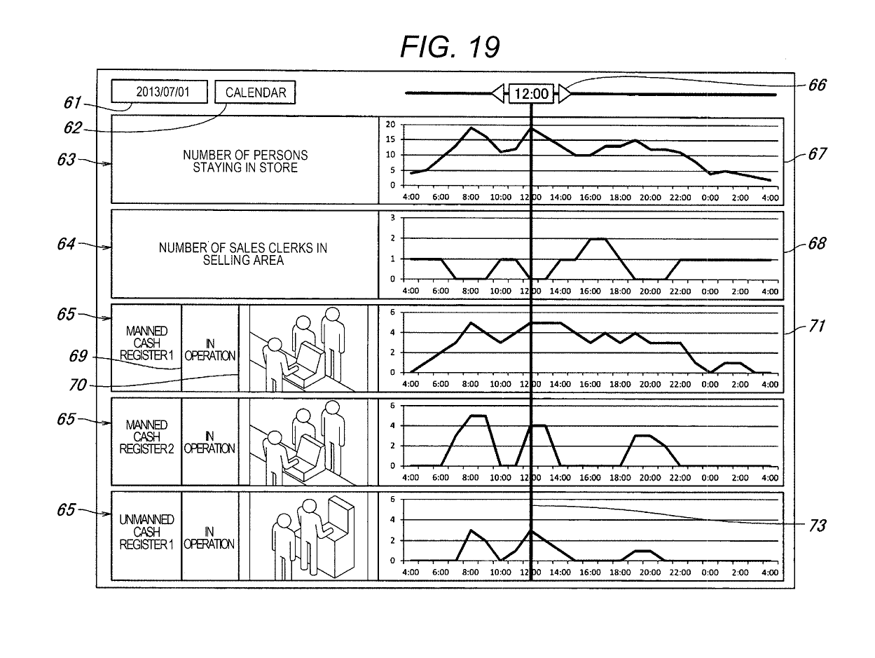

An example shown in FIG. 19 is a case where display time point operation part 66 is matched with the time point when no alerts are made. As shown in FIG. 14A, the inside of the store in this case is in a state where there are a lot of persons staying in the store, that is, the store is crowded, a state where the number of sales clerks in the selling area is 0, that is, there is no sales clerk staying in the selling area, a state where there are a lot of customers waiting at manned cash register 6 for the payment, and a state where there is the customer waiting at unmanned cash register 7 for the payment, the alert is not made according to the procedure shown in FIG. 9.

The payment operation situation display screen shown in FIGS. 17 to 19 can be displayed on monitor 4 of the store and monitor 12 of the head office, it is possible for the store manager to browse the screen by displaying the screen on monitor 4 of the store, and it is possible for the supervisor to browse the screen by displaying the screen on monitor 12 of the head office, and it is possible to easily grasp whether or not the payment operation of the sales clerk is appropriately executed with respect to the occurrence of the alert.

The number of persons (the number of persons staying in the store, the number of sales clerks in the selling area, and the number of persons waiting for the payment) output at each detection time point at predetermined detection intervals (for example, intervals of 5 minutes) from person-in-store state detector 42, sales clerk state detector 43, and payment waiting state detector 41 may be displayed as they are on graph display parts 67, 68, and 71, but totalizer 48 may totalize the number of persons at each detection time point in the predetermined total unit period (for example, 1 hour) to display the number of persons for each total unit period.

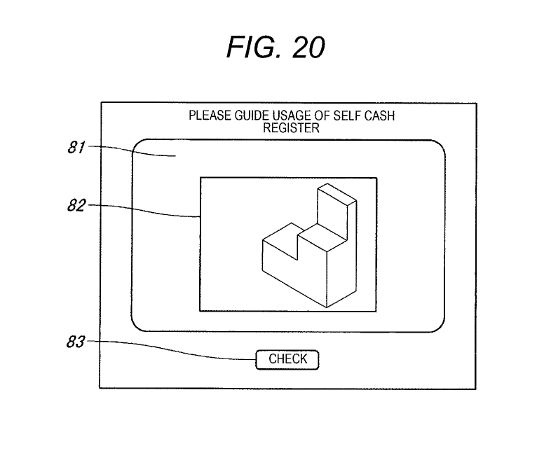

Next, the alert screen for making the alert with respect to the sales clerk or the store manager using portable terminal 5 shown in FIG. 1 will be described. FIG. 20 is an explanatory diagram showing the alert screen displayed on portable terminal 5.

In the embodiment, the alert is made with respect to the sales clerk or the store manager using portable terminal 5 (tablet terminal or smart phone) carried by the sales clerk or the store manager, the alert screen shown in FIG. 20 is displayed on portable terminal 5, and it is possible for the sales clerk or the store manager to recognize the alert contents by browsing the alert screen.

This alert screen is provided with comment display part 81, image display part 82, and check button 83. The text representing the alert contents is displayed on comment display part 81. The image of the area relating to the alert contents is displayed on image display part 82. An example shown in FIG. 20 is a case of the alert instructing the guidance recommending using unmanned cash register 7 to the customer waiting for the payment at manned cash register 6 (unmanned cash register guidance alert), and the image obtained by imaging the payment waiting area of unmanned cash register 7 is displayed on image display part 82.

When the sales clerk browses the alert screen and operates check button 83, the alert indicating the alert screen browsed is transmitted to PC 3, and accordingly, it is possible for the store manager or the supervisor to grasp that the sales clerk has browsed the alert screen.

FIG. 20 shows a case of the unmanned cash register guidance alert, but the other alerts may be made in the same manner.

Next, the alert situation display screen displayed on monitor 4 of the store or monitor 12 of the head office shown in FIG. 1 will be described. FIGS. 21A and 21B are explanatory diagrams showing the alert situation display screen displayed on monitor 4 of the store or monitor 12 of the head office.

The alert situation display screen shown in FIG. 21A shows the occurrence situation of the alert of one store, and the alert situation display screen shown in FIG. 21B shows comparison of the occurrence situations of the alerts of the plurality of stores. The temporal transitional situations of the number of times of the alert are displayed on alert situation display screen as a graph (line graph). Particularly, in the examples shown in FIGS. 21A and 21B, the transitional situations of the number of time of the alert for each day are displayed as a graph, and a horizontal axis of the graph indicates the day and a vertical axis of the graph indicates the number of time of the alert.

As described above, totalizer 48 performs a process of totalizing the occurrence time points of the alerts in the predetermined total period unit and obtaining the number of time of the alert in each total period, and herein, by obtaining the number of time of the alert for each day by setting the total unit period as one day, it is possible to generate the alert situation display screen shown in FIGS. 21A and 21B.

The alert situation display screen shown in FIG. 21A is displayed on monitor 4 of the store and monitor 12 of the head office, and when the store manager or the supervisor browses this, it is possible for the store manager or the supervisor to grasp the occurrence situations of the alerts in one store. The alert situation display screen shown in FIG. 21B is displayed on monitor 12 of the head office, and when the supervisor browses this, it is possible for the supervisor to grasp the comparison of the occurrence situations of the alerts in the plurality of stores.

In the examples shown in FIGS. 21A and 21B, the transitional situations of the number of time of the alert for each day are displayed by using the total unit period as one day, but the number of time of the alert for each week may be displayed by using the total unit period as one week, or the number of time of the alert for each month may be displayed by using the total unit period as one month.

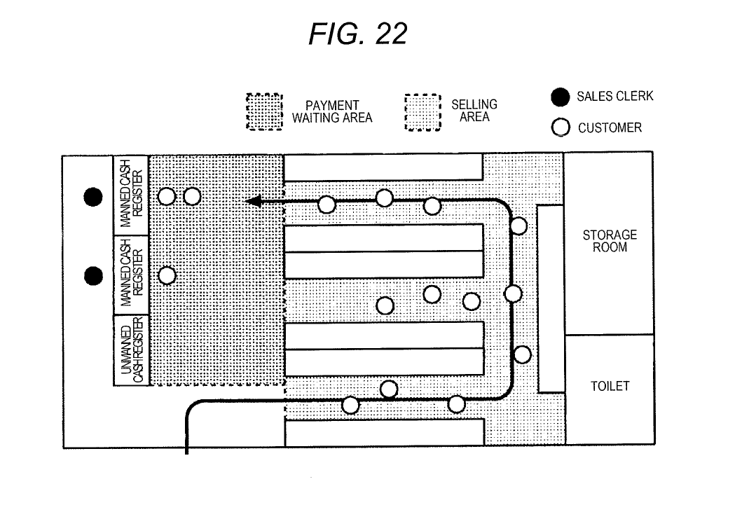

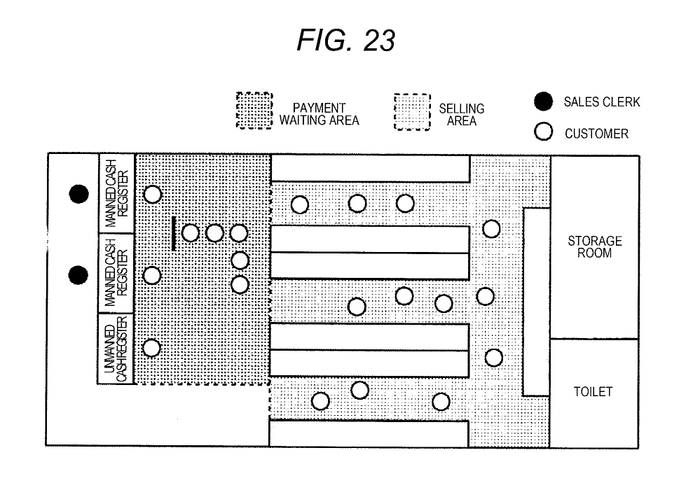

Next, a modification example of the payment service support system according to the embodiment will be described. FIGS. 22 and 23 are explanatory examples illustrating situations in the store of a modification example of the payment service support system according to the embodiment.

In the embodiment described above, person-in-store state detector 42 measures the number of persons staying in the store and detects the crowded state of the entire store, and alert determinator 45 determines advisability of the alert based on the crowded state of the entire store, but the advisability of the alert may be determined according to the stay position of the customer in the store.

For example, the customer visiting the store moves in the store as shown with an arrow and the customer staying in the upstream area of a traveling route of the customer does not directly make a payment. Particularly, the display shelf of the magazines is installed in the vicinity of the entrance of the store, and the customer browsing the magazines herein does not directly make a payment. Accordingly, even when a lot of customers stay in the upstream area of the travelling route of the customer, when there is the small number of customers staying in the downstream area of the travelling route, it is not necessary to instruct the sales clerk to perform the action to decrease the customer's waiting time for the payment.

Therefore, person-in-store state detector 42 measures the number of persons staying in each area set for each display shelf (see FIG. 4), and alert determinator 45 determines the advisability of the alert based on the number of persons staying in each area. For example, the number of persons staying in the upstream area of the traveling route is evaluated to be smaller than the number of persons staying in the downstream area of the travelling route to obtain a crowded level, and alert determinator 45 determines the advisability of the alert based on the crowded level.

In the embodiment described above, the case where the customers waiting for the payment make a line at each of the plurality of manned cash registers 6 has been described, but the customers waiting for the payment may stand in a line, as shown in FIG. 23. In this case, payment waiting state detector 41 measures the number of persons waiting for the payment at the plurality of manned cash registers 6, and the number of graph display part 71 of payment waiting state display part 65 shown in FIGS. 17 to 19 relating to manned cash registers 6 are one. At unmanned cash register 7, customers make a line separately from that of manned cash registers 6.

As described above, in the embodiment, since payment waiting state detector 41 detects the state of the customers waiting for the payment from the image, person-in-store state detector 42 detects the state of the persons staying in the store from the image, and alert determinator 45 determines the advisability of the alert by considering both of the state of the customer waiting for the payment and the state of the person staying in the store, it is possible to optimize the timing of the alert and to decrease the unnecessary alerts.

In the embodiment, when alert determinator 45 determines that manned cash register 6 can be newly operated, based on the detected result of sales clerk state detector 43 and the detected result of cash register state detector 44, it is determined to make the alert of instructing the operation of manned cash register 6, and therefore, it is possible to decrease the unnecessary alerts. That is, when it is difficult to newly operate manned cash register 6, although the alert instructing the operation of manned cash register 6 is made, this merely results in the unnecessary operation of the sales clerk. When it is possible to newly operate manned cash register 6, it is possible to avoid the unnecessary operation of the sales clerk by making the alert of instructing the operation of manned cash register 6.

In the embodiment, when payment waiting state detector 41 detects that there are a lot of customers waiting for the payment and person-in-store state detector 42 detects that the store is not crowded, alert determinator 45 makes a determination not to make the alert, and therefore, it is possible to decrease the unnecessary alerts. That is, even when there are a lot of the customers waiting for the payment, in a state where the store is not crowded, an immediate decrease in the number of customers waiting for the payment is expected. In such a case, even when the action to decrease the customer's waiting time for the payment is performed, this may be an unnecessary action, in many cases, and it is possible to avoid the unnecessary action of the sales clerk by not making the alert in this case.

In the embodiment, when payment waiting state detector 41 detects that there are a lot of customers waiting at manned cash registers 6 for the payment, alert determinator 45 makes a determination to make the alert of instructing guidance recommending using unmanned cash register 7 to the customer waiting at manned cash register 6 for the payment, and it is possible to decrease the customer's waiting time for the payment, when the customer uses unmanned cash register 7 according to the guidance recommending using unmanned cash register 7 to the customer waiting at manned cash register 6 for the payment.

In the embodiment, when payment waiting state detector 41 detects that there are a lot of customers waiting at manned cash registers for the payment, and it is determined that it is difficult to newly operate manned cash register 6, based on the detected result of sales clerk state detector 43 and the detected result of cash register state detector 44, alert determinator 45 makes a determination to make the alert of instructing guidance recommending using unmanned cash register 7 to the customer waiting at manned cash register 6 for the payment. When it is determines that manned cash register 6 can be newly operated, alert determinator 45 makes a determination to make the alert of instructing the operation of manned cash register 6, when it is determined that it is difficult newly operate manned cash register 6, the guidance recommending using unmanned cash register 7 to the customer is performed, and when manned cash register 6 can be newly operated, manned cash register 6 is operated to perform the payment operation, and therefore, it is possible to increase customer satisfaction.

In the embodiment, when payment waiting state detector 41 detects that there are a lot of customers waiting for the payment, person-in-store state detector 42 detects that the store is crowded, sales clerk state detector 43 detects that there is the sales clerk who can participate in the payment operation, and cash register state detector 44 detects that all of manned cash registers 6 are already operated, alert determinator 45 makes a determination to perform the alerting of instructing the support of the payment operation at manned cash registers 6. Even when it is difficult to newly operate manned cash registers 6, when there is the sales clerk who can participate in the payment operation, the alert of instructing the support of the payment operation is made to cause the other sales clerks to work for the assistance operation of assisting the sales clerk operating manned cash register 6, and accordingly, it is possible to shorten the time required for the payment, and therefore, it is possible to decrease the customer's waiting time for the payment.

In the embodiment, when payment waiting state detector 41 detects that there is the small number of customers waiting for the payment, person-in-store state detector 42 detects that the store is crowded, and sales clerk state detector 43 detects that there is the sales clerk who can participate in the payment operation, alert determinator 45 makes a determination to make the alert of instructing the assembly in the payment operation area. Even when the number of customers waiting for the payment is small, when the store is crowded, since an immediate rapid increase in the number of customers making a payment is expected, when there is the sales clerk who can participate in the payment operation, the alert of instructing the assembly in the payment operation area is made to cause the sales clerk to be on standby in the payment operation area, and accordingly, it is possible to rapidly deal with the operations, even when the number of customers making a payment is rapidly increased.

In the embodiment, since information storage 47 stores information regarding the alerts made by alert executer 46, totalizer 48 obtains the total result relating to the occurrence situations of the alerts based on the information stored in information storage 47, and screen information generator 51 generates the display information regarding the occurrence situations of the alerts based on the total result obtained by totalizer 48, it is possible for a user to simply grasp the occurrence situations of the alerts in the past.

In the embodiment, since information storage 47 stores information regarding the payment waiting state at each detection time point obtained by payment waiting state detector 41, information regarding the person-in-store state at each detection time point obtained by person-in-store state detector 42, and information regarding the alerts made by alert executer 46, and screen information generator 51 generates the display information by combining the temporal transitional situations of the payment waiting customer state, the temporal transitional situations of the person-in-store state, and occurrence situations of the alerts, based on the information stored in information storage 47, it is possible for a user to grasp timing in which the alert has occurred, by comparison with the temporal transitional situations of the payment waiting customer state or the temporal transitional situations of the person-in-store state.

Hereinabove, the invention has been described based on the specific embodiments, but the embodiments are merely examples, and the invention is not limited to the embodiments. Not all of constituent elements of the payment service support apparatus, the payment service support system, and the payment service support method according to the invention shown in the embodiments are necessary, and it is possible to appropriately remove and delete the constituent elements in a range of not departing from the scope of the invention.

For example, in the embodiment, the example of a retail store such as a convenience store has been described, but there is no limitation to the retail store, and the invention can also be applied to a store with an operation format other than that of the retail store.

In the embodiment, payment waiting state detector 41, person-in-store state detector 42, and sales clerk state detector 43 separately perform the person detection process, but a person detector which detects the person staying in the store may be provided based on the image obtained by imaging the inside of the store by cameras 1, and payment waiting state detector 41, person-in-store state detector 42, and sales clerk state detector 43 may separately perform a detection process, based on the detected result obtained by the person detector. A part of or the entire functions of the person detection performed by this person detector may be configured by another apparatus or can be integrated with camera 1 so as to be configured as a person detection function-attached imaging device.

In the embodiment, payment waiting state detector 41 and person-in-store state detector 42 measure the number of persons (number of persons waiting for the payment and number of persons staying in the store), and alert determinator 45 performs the determination whether or not there are a lot of customers waiting for the payment (determination of the payment waiting state) and determination whether or not the store is crowded (determination of person-in-store state), based on the number of persons, but, without measuring the number of persons in payment waiting state detector 41 and person-in-store state detector 42, a stay level (crowded level) in the payment waiting area or in the store may be obtained from a rate of an area having objects assumed as the person in the image of the payment waiting area or the image of the inside of the store, and the determination of the payment waiting state or the determination of the person-in-store state may be performed based on the stay level.

In the embodiment, as shown in FIG. 20, the alert screen is displayed on portable terminal 5 carried by the sales clerk or the store manager to make the alert with respect to the sales clerk or the store manager, that is, the output device for the alert is set as portable terminal 5, but the alert may be made by using a suitable output device such as a speaker or a lamp installed in the store.

In the embodiment, as shown in FIGS. 17 to 19, the image of the payment operation area or the payment waiting area is displayed on image display part 70 of the payment operation situation display screen, but the customers may be displayed on this image, and in this case, it is desirable to display the image in a form of protecting privacy of the customer. For example, it is preferable to delete the person who is confirmed as a person other than the sales clerk or to perform a mosaic process on an image of the face of a person who is confirmed as a person other than the sales clerk, so that the individual persons are not specified. Particularly, when the person who is confirmed as a person other than the sales clerk is deleted, only the sales clerks are in the image, and it is advantageous to easily grasp the execution situations of the operation of the sales clerk.

In the embodiment, the process necessary for the payment service support is performed in PC 3 provided in the store, but the necessary process may be performed in PC 11 provided in the head office or in cloud computer 21 configuring a cloud computing system, as shown in FIG. 1. The necessary process may be shared by a plurality of information processing apparatuses, and information may be transmitted to and received from the plurality of information processing apparatuses through a communication medium such as an IP network or a LAN. In this case, the payment service support system is configured with the plurality of information processing apparatuses sharing the necessary process.

In the configurations described above, among the processes necessary for the payment service support, at least a process having a large operation amount, for example, the person detection process, may be performed by PC3 provided in the store. By configuring as described above, since the amount of data of necessary information in the remaining processes is small, accordingly, even when the remaining processes are caused to perform by an information processing apparatus installed in another place different from the store, it is possible to decrease a communication load, and therefore, it is easy to operate the system by broad area network connection configuration.

Among the processes necessary for the payment service support, at least a process having a large operation amount, for example, the person detection process, may be performed by cloud computer 21. By configuring as described above, since an operation amount of the remaining process is small, a high-speed information processing apparatus is not necessary on the user side such as a store, and it is possible to reduce cost shouldered by a user.

Cloud computer 21 may perform all of the necessary processes or at least the display information generation process among the necessary processes may be shared by cloud computer 21. By configuring as described above, in addition to PC 3 and PC 11 provided in the store or the head office, it is also possible to display the display information (such as a payment operation situation display screen) on a portable terminal (such as a tablet terminal or a smart phone) 22, and therefore, it is possible to check the payment operation situations at an arbitrary place such as places other than the store or the head office.

In the embodiment, PC 3 installed in the store performs the process necessary for the payment service support, and the display information (such as a payment operation situation display screen) generated by PC 3 is browsed on monitor 4 of PC 3 or monitor 12 of PC 11 installed in the head office, but a browsing device of the display information can be provided separately from PC 3 and PC 11, for example, the portable terminal (such as a tablet terminal or a smart phone) 22 can be set as the browsing device of the display information as described above, or a function as the browsing device of the display information can be added to the sales information management apparatus installed in the store. The display information can also be output using a printer.

In the embodiment, PC 3 installed in the store performs the process necessary for the payment service support and the necessary input operation such as input of the set matters are performed by PC 3, but the necessary input operation may be performed by PC 11 installed in the head office, or the necessary input operation may be performed by the information processing apparatus other than PC 3 and PC 11, for example, the portable terminal 22.

The payment service support apparatus, the payment service support system, and the payment service support method according to the invention have an effect of optimizing the alert timing and decreasing the unnecessary alerts, when making the alert of instructing the sales clerk act to decrease the customer's waiting time for the payment, and are useful as a payment service support apparatus, a payment service support system, and a payment service support method which support the payment service in the store so as to decrease the customer's waiting time for the payment, based on an image obtained by imaging the inside of the store.

What is claimed is:

1. A payment service support apparatus which supports payment service in a store so as to decrease customer's waiting time for payment based on an image obtained by imaging the inside of the store, the apparatus comprising:
a processor; and
a memory which stores instructions,
wherein the payment service support apparatus further includes, as a configuration when the processor executes the instructions stored in the memory,
a payment waiting state detector which detects a state of a customer waiting for a payment, based on an image obtained by imaging a payment waiting area where customers waiting at a cash register for a payment stay,
a person-in-store state detector which detects a state of persons staying in the store, based on an image obtained by imaging the inside of the store,
an alert determinator which determines advisability of an alert instructing an action to decrease the customer's waiting time for the payment, based on the detected result of the payment waiting state detector and the detected result of the person-in-store state detector, and
an alert executer which makes the, based on the determined result of the alert determinator.

2. The payment service support apparatus of claim 1, further comprising:
a sales clerk state detector which detects a state of the sales clerk staying in the store, based on the image obtained by imaging the inside of the store; and
a cash register state detector which detects the state of the cash register,
wherein the alert determinator makes a determination to make an alert of instructing an operation of the cash register, when it is determined that the cash register is able to be newly operated, based on the detected result of the sales clerk state detector and the detected result of the cash register state detector.

3. The payment service support apparatus of claim 1,
wherein the alert determinator makes a determination not to make an alert, when the payment waiting state detector detects that there are a lot of customers waiting for the payment and the person-in-store state detector detects that the store is not crowded.

4. The payment service support apparatus of claim 1,
wherein manned cash registers and unmanned cash registers are installed in the store, and
the alert determinator makes a determination to perform an alert of instructing guidance recommending using the unmanned cash register to the customer waiting at the manned cash registers for the payment, when the payment waiting state detector detects that there are a lot of customers waiting at the manned cash register for the payment.

5. The payment service support apparatus of claim 4, further comprising:
a sales clerk state detector which detects a state of the sales clerk staying in the store, based on the image obtained by imaging the inside of the store; and
a cash register state detector which at least detects a state of the manned cash registers,
wherein the alert determinator makes a determination to make the alert of instructing guidance recommending using the unmanned cash register to the customer waiting at the manned cash registers for the payment, when the payment waiting state detector detects that there are a lot of customers waiting at the manned cash register for the payment and when it is determined that it is difficult to newly operate the manned cash register, based on the detected result of the sales clerk state detector and the detected result of the cash register state detector, and
the alert determinator makes a determination to make the alert of instructing the operation of the manned cash register, when it is determined that the manned cash register is able to be newly operated.

6. The payment service support apparatus of claim 1, further comprising:
a sales clerk state detector which detects a state of the sales clerk staying in the store, based on the image obtained by imaging the inside of the store; and
a cash register state detector which detects the state of the cash register,
wherein the alert determinator makes a determination to make an alert of instructing support of a payment operation at the cash register, when the payment waiting state detector detects that there are a lot of customers waiting for the payment, the person-in-store state detector detects that the store is crowded, the sales clerk state detector detects that there is a sales clerk who is able to participate in the payment operation, and the cash register state detector detects that all of the cash registers are already operated.

7. The payment service support apparatus of claim 1, further comprising:
a sales clerk state detector which detects a state of the sales clerk staying in the store, based on the image obtained by imaging the inside of the store,
wherein the alert determinator makes a determination to make an alert of instructing assembly in a payment operation area where the sales clerks perform the payment operation, when the payment waiting state detector detects that there is a small number of customers waiting for the payment, the person-in-store state detector detects that the store is crowded, and the sales clerk state detector detects that there is a sales clerk who is able to participate in the payment operation.

8. The payment service support apparatus of claim 1, further comprising:
an information storage which stores information regarding the alert made by the alert executer;
a totalizer which obtains a totalized result relating to occurrence situations of the alerts, based on the information stored in the information storage; and
a display information generator which generates display information regarding the occurrence situations of the alerts, based on the totalized result obtained by totalizer.

9. The payment service support apparatus of claim 1, further comprising:
an information storage which stores information regarding a payment waiting state in each detection time point obtained by the payment waiting state detector, information regarding the person-in-store state in each detection time point obtained by the person-in-store state detector, and information regarding the alerts made by the alert executer; and
a display information generator which generates display information of combination of temporal transitional situations of the payment waiting customer state, temporal transitional situations of the person-in-store state, and occurrence situations of the alerts, based on the information items stored in the information storage.

10. A payment service support system which supports a payment service in a store so as to decrease customer's waiting time for the payment based on an image obtained by imaging the inside of the store, the system comprising:
cameras which image the inside of a store; and
a plurality of information processing apparatuses,
wherein any one of the plurality of information processing apparatuses includes
a payment waiting state detector which detects a state of a customer waiting for a payment, based on an image obtained by imaging a payment waiting area where customers waiting at a cash register for a payment stay,
a person-in-store state detector which detects a state of persons staying in the store, based on an image obtained by imaging the inside of the store,
an alert determinator which determines advisability of an alert instructing an action to decrease the customer's waiting time for the payment, based on the detected result of the payment waiting state detector and the detected result of the person-in-store state detector, and
an alert executer which makes the alert, based on the determined result of the alert determinator.

11. A payment service support method which causes an information processing apparatus to perform a process of supporting a payment service in a store so as to decrease a customer's waiting time for a payment based on an image obtained by imaging the inside of the store, the method comprising:
a first step of detecting a state of the customer waiting for the payment, based on an image obtained by imaging a payment waiting area where customers waiting at a cash register for a payment stay;
a second step of detecting a state of persons staying in the store, based on an image obtained by imaging the inside of the store;
a third step of determining advisability of an alert instructing an action to decrease the customer's waiting time for the payment, based on the detected result of the step of detecting a state of the customer waiting for the payment and the detected result of the step of detecting a state of persons staying in the store; and
a fourth step of making the alert, based on the determined result of the above steps,
wherein at least one of the first step to the fourth step is executed by a processor.
